(19) United States
(12) Patent Application Publication
(10) Pub. No.: US 2026/0112682 A1
(43) Pub. Date: Apr. 23, 2026

(54) CATHODE FRAMES FOR USE IN SOLID-STATE BATTERIES

(71) Applicant: QUANTUMSCAPE BATTERY, INC., San Jose, CA (US)

(72) Inventors: Saori Tokuoka, San Jose, CA (US); Ran Tao, San Jose, CA (US); Alexandra Lazar, San Jose, CA (US)

(21) Appl. No.: 19/428,550

(22) Filed: Dec. 22, 2025

Related U.S. Application Data
(63) Continuation of application No. PCT/US2025/025457, filed on Apr. 18, 2025.
(60) Provisional application No. 63/636,655, filed on Apr. 19, 2024.

(51) Int. Cl. H01M 10/04

(52) U.S. Cl. CPC H01M 10/0486

(57) ABSTRACT

The present disclosure concerns electrochemical stacks with frames for solid-state cathodes and processes of assembling electrochemical stacks with frames for solid-state batteries.

### CROSS-REFERENCE TO RELATED APPLICATIONS

This application is a Continuation of International Patent Application No. PCT/US2025/025457, filed Apr. 18, 2025, which claims priority to, and the benefit of, U.S. Provisional Patent Application No. 63/636,655, filed Apr. 19, 2024, the entire contents of which are herein incorporated by reference in its entirety for all purposes.

### FIELD

The present disclosure concerns electrochemical stacks with frames for solid-state cathodes and processes of assembling electrochemical stacks with frames for solid-state batteries.

### BACKGROUND

Solid-state lithium batteries have a number of advantages over conventional lithium batteries that rely solely on liquid-based electrolytes. However, solids by their very nature are less deformable than liquids, making stack assembly more challenging. One challenge is maintaining the structural integrity of battery components during assembly.

There is therefore a need for electrochemical stacks with frames for solid-state cathodes and processes to assemble electrochemical stacks with frames. The instant disclosure sets forth such electrochemical stacks and processes.

### SUMMARY

In a first aspect, the present disclosure provides an electrochemical stack that includes a) a solid-state cathode having two major surfaces, four minor surfaces, a first width and a first length, the solid-state cathode comprising a solid catholyte; b) a solid-state separator having a second width and a second length; c) a cathode current collector; d) a bonding layer; and e) a frame; wherein the frame surrounds the four minor surfaces of the solid-state cathode; wherein the frame is positioned between and contacts the cathode current collector and the solid-state separator; wherein the bonding layer is positioned between and contacts the solid-state cathode and the solid-state separator; and wherein the first width is smaller than the second width; and the first length is smaller than the second length.

In a second aspect, the present disclosure provides an electrochemical stack that includes: a) a solid-state cathode having two major surfaces and four minor surfaces, the solid-state cathode comprising a solid catholyte; b) a solid-state separator; c) a cathode current collector; d) a bonding layer; and e) a frame surrounding the four minor surfaces of the solid-state cathode; wherein the frame is positioned between and contacts the cathode current collector and the solid-state separator; wherein the bonding layer is positioned between and contacts the solid-state cathode and the solid-state separator.

In a third aspect, the present disclosure provides a method of assembling an electrochemical stack, in which the method includes: (1) providing an electrochemical stack; wherein the electrochemical stack comprises: a frame as described herein; a solid-state cathode, a bonding layer, and a solid-state separator; and (2) applying pressure of about 70 kPa to about 700 kPa the electrochemical stack.

In a fourth aspect, the present disclosure provides a method of assembling an electrochemical stack, the method including:
(1) providing a frame as described herein;
(2) providing a solid-state cathode with a bonding layer on one major surface of the solid-state cathode;
(3) placing the solid-state cathode within the frame, wherein the frame surrounds all four minor surfaces of the solid-state cathode, thus forming a sub-stack;
(4) applying a pressure of about 70 kPa to about 700 kPa at a temperature of about 65° C. to about 75° C. to the sub-stack;
(5) placing a solid-state separator on top of the bonding layer, thus forming an electrochemical stack; and
(6) applying a pressure of about 70 kPa to about 700 kPa at a temperature of about 80° C. to about 160° C. to the electrochemical stack.

In a fifth aspect, the present disclosure provides a method of assembling an electrochemical stack, the method including:
(1) providing a frame as described herein;
(2) placing a solid-state cathode within the frame, wherein the frame surrounds all four minor surfaces of the solid-state cathode, thus forming a sub-stack;
(3) applying a pressure of about 70 kPa to about 700 kPa at a temperature of about 65° C. to about 75° C. to the sub-stack;
(4) providing a solid-state separator with a bonding layer;
(5) placing the solid-state cathode with frame on top of the bonding layer, thus forming an electrochemical stack; and
(6) applying a pressure of about 70 kPa to about 700 kPa at a temperature of about 80° C. to about 160° C. to the electrochemical stack.

In a sixth aspect, the present disclosure provides a method of assembling an electrochemical stack, the method including:
(1) providing a frame as described herein;
(2) placing the frame on top of a solid-state separator, thus forming a sub-stack;
(3) applying a pressure of about 70 kPa to about 700 kPa at a temperature of about 65° C. to about 75° C. to the sub-stack;
(4) providing a solid-state cathode with a bonding layer on one major surface of the solid-state cathode;
(5) placing the solid-state cathode with bonding layer on top of the solid-state separator with frame, wherein the frame surrounds the four minor surfaces of the solid-state-cathode and that the bonding layer contacts the solid-state separator, thus forming an electrochemical stack;
(6) applying a pressure of about 70 kPa to about 700 kPa at a temperature of about 80° C. to about 160° C. to the electrochemical stack.

In a seventh aspect, the present disclosure provides a method of assembling an electrochemical stack, the method including:
(1) providing a frame as described herein;
(2) providing a solid-state separator with a bonding layer;
(3) placing the frame on top of the solid-state separator;
(4) applying a pressure of about 70 kPa to about 700 kPa at a temperature of about 65° C. to about 75° C.;
(5) placing a solid-state cathode on top of the solid-state separator with frame, wherein the frame surrounds the four minor surfaces of the solid-state-cathode and wherein the bonding layer contacts the solid-state cathode, thus forming an electrochemical stack; and
(6) applying a pressure of about 70 kPa to about 700 kPa at a temperature of about 80° C. to about 160° C. to the electrochemical stack.

In an eighth aspect, the present disclosure provides a method of assembling an electrochemical stack, the method including:
(1) providing a frame as described herein;
(2) providing a solid-state cathode with a bonding layer on one major surface of the solid-state cathode;
(3) placing the solid-state cathode within the frame, wherein the frame surrounds the four minor surfaces of the solid-state cathode and placing a solid-state separator on top of the bonding layer, thus forming an electrochemical stack;
(4) applying a pressure of about 70 kPa to about 700 kPa at a temperature of about 65° C. to about 75° C. to the electrochemical stack; and
(5) applying a pressure of about 70 kPa to about 700 kPa at a temperature of about 80° C. to about 160° C. to the electrochemical stack.

In a ninth aspect, the present disclosure provides a method of assembling an electrochemical stack, the method including:
(1) providing a frame as described herein;
(2) providing a solid-state separator with a bonding layer;
(3) placing a solid-state cathode within the frame, wherein the frame surrounds the four minor surfaces of the solid-state cathode and placing the solid-state separator with bonding layer on top of the solid-state cathode with frame, wherein the bonding layer contacts the solid-state cathode, thus forming an electrochemical stack;
(4) applying a pressure of about 70 kPa to about 700 kPa at a temperature of about 65° C. to about 75° C. to the electrochemical stack;
(5) applying a pressure of about 70 kPa to about 700 kPa at a temperature of about 80° C. to about 160° C. to the electrochemical stack.

### BRIEF DESCRIPTION OF THE DRAWINGS

FIG. 1 is a cross-sectional image of an electrochemical stack comprising a frame surrounding a solid-state cathode and contacting a solid-state separator and a cathode current collector.

FIG. 2 is a vertical stacked image of an electrochemical stack comprising a frame positioned between a solid-state separator and a cathode current collector.

FIG. 3A is a cross-sectional image of a frame comprising three layers, each with a layer thickness.

FIG. 3B is a cross-sectional image of a frame comprising two layers, each with a layer thickness.

FIG. 4 is a top-down image of a frame surrounding a solid-state cathode.

FIG. 5 is a three-dimensional image of solid-state cathode with four minor surfaces and two major surfaces.

FIG. 6 is an image demonstrating the effects of compressing an electrochemical stack with and without a frame.

FIG. 7 is a cross-sectional image of an electrochemical stack comprising a frame that includes two layers, surrounds a solid-state cathode, and contacts a solid-state separator and a cathode current collector.

FIG. 8 is a cross-sectional image of an electrochemical stack that includes a frame that includes three layers, surrounds a solid-state cathode, and contacts a solid-state separator and a cathode current collector.

FIG. 9 is a top-down image of a frame as disclosed herein.

FIG. 10 is a top-down image of a frame as disclosed herein, with an opening.

FIG. 11 is a cross-sectional image of a frame comprising three layers, with one of the layers having an opening.

FIG. 12 is a cross-sectional image of a frame comprising two layers, with one of the layers having an opening.

### DETAILED DESCRIPTION

### I. Definitions

As used herein, the term “about,” when qualifying a number, e.g., 15% w/w, refers to the number qualified and optionally the numbers included in a range about that qualified number that includes ±10% of the number. For example, about 15% percent by weight (w/w) includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C. For example, evaporating a solvent at about 80° C. includes evaporating a solvent at 79° C., 80° C., or 81° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including a cathode and an anode, which have ionic communication between the two using an electrolyte. In some embodiments, the same battery cell includes multiple cathodes and/or multiple anodes enclosed in one container.

As used herein, the term “surface” refers to material that is at an interface between two different phases, chemicals, or states of matter. For example, a solid-state electrolyte separator when exposed to air has a surface described by the periphery or outside portion of the separator that contacts the air. For rectangular-shaped film separators, there is a top and a bottom surface (or major surfaces) which both individually have higher surface areas than each of the four side surfaces (or minor surfaces) individually. In this rectangular separator example, there are four side surfaces which individually have surface areas less than either or both of the top and bottom surfaces. For disc-shaped film separators, there is a top and a bottom surface which both individually have higher surface areas than the circumference-side of the disc. When used as an electrolyte separator in an electrochemical cell, the top or bottom surface is the side or part of the separator that contacts the anode (i.e., Li metal), the cathode or catholyte in cathode, and/or a layer or bonding agent disposed between the electrolyte separator and the cathode. A surface has larger x- and y-axis physical dimensions than it does z-axis physical dimensions, wherein the z-axis is the axis perpendicular to the surface. The depth or thickness of a surface can be of molecular order of magnitude or up to 1 micron. Film surfaces can include dangling bonds, excess hydroxyl groups, bridging oxides, or a variety of other species which result in the film surface having a chemical composition that may be stoichiometrically different from the bulk. As used herein, the term “bulk,” refers to a portion or part of the film that is extended in space in three-dimensions by at least 1 micron. The bulk refers to the portion or part of a material which is exclusive of its surface, as defined above.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. The cathode active material is not particularly limited herein, and a publicly known cathode active material utilized in all-solid-state batteries can be used. Specific examples of such a cathode active material include the following: manganese oxide (MnO), iron oxides, copper oxides, nickel oxides, lithium-manganese complex oxides (e.g., LiMn₂O₄ or LiMnO₂), lithium-nickel complex oxides (e.g., LiNiO₂), lithium-cobalt complex oxides (e.g. LiCoO2), lithium cobalt nickel oxides (LiNi_{1-y}Co_{y}O₂), lithium-manganese-cobalt complex oxides (e.g., LiMn_{y}Co_{1-y}O₂), lithium-nickel-manganese-cobalt oxides (e.g. LiNiₓMn_{y}Co_{1-x-y}O₂), lithium-nickel-cobalt-aluminum oxides (e.g. LiNiₓAl_{y}Co_{1-x-y}O₂), spinel-phase lithium-manganese-nickel complex oxides (e.g., LiMn_{1.5}Ni_{0.5}O₄), lithium phosphates having an olivine structure (e.g., LiFePO₄, which is also known as LFP, and LiCoPO₄), lithium iron manganese phosphates (e.g., LiFeMnPO₄, also known as LMFP), lithium phosphates having a NASICON-type structure (e.g., Li₇V₂(PO₄)₃), iron (III) sulfate (Fe₂(SO₄)₃), and vanadium oxides (e.g., V₂O₅). One type thereof can be used alone, or two or more types thereof can be used in combination. Preferably, x and y in these chemical formulas lie within the ranges of 0<x<1, and 0<y<1.

As used herein, a “catholyte” refers to an ion conductor that is intimately mixed with, or that surrounds, or that contacts the cathode active material. Catholytes suitable with the embodiments described herein include, but are not limited to, catholytes having the common name LPS, LXPS, LXPSO, where X is Si, Ge, Sn, As, Al, LATS, or also Li-stuffed garnets, or combinations thereof, and the like. Catholytes include those catholytes set forth in US Patent Application Publication No. 2015-0171465, which published on Jun. 18, 2015, entitled SOLID STATE CATHOLYTE OR ELECTROLYTE FOR BATTERY USING Li_{A}MP_{B}S_{C} (M=Si, Ge, AND/OR Sn), the contents of which are incorporated by reference in their entirety.

As used herein, the phrase “solid-state cathode” refers to a cathode which does not include a liquid-phase electrolyte.

As used herein, the phrase “double-sided solid-state cathode” refers to two solid-state cathode layers separated by one or two cathode current collectors disposed in between the two layers.

As used herein, the phrase “solid-state catholyte,” “solid catholyte” or the term “catholyte” refers to an ion conductor that is intimately mixed with, or surrounded by, a cathode active material that is a solid.

As used herein, the phrase “current collector” refers to a component or layer in a secondary battery through which electrons conduct, to or from an electrode in order to complete an external circuit, and which are in direct contact with the electrode to or from which the electrons conduct. In some embodiments, the current collector is a metal (e.g., Al, Cu, or Ni, steel, alloys thereof, or combinations thereof) layer which is laminated to a cathode or an anode. In some embodiments, the current collector is Al. In some embodiments, the current collector is Cu. In some embodiments, the current collector is Ni. In some embodiments, the current collector is steel. In some embodiments, the current collector is an alloy of Al. In some embodiments, the current collector is an alloy of Cu. In some embodiments, the current collector is an alloy of steel. In some embodiments, the current collector is Al. In some embodiments, the current collector is coated with carbon. In some embodiments, the current collector comprises a combination of the above metals. During charging and discharging, electrons move in the opposite direction to the flow of Li ions and pass through the current collector when entering or exiting an electrode.

As used herein, the phrase “bonding layer” refers to a layer which includes a borohydride compound and which adheres a lithium-stuffed garnet layer to a sulfide electrolyte layer or sulfide including buffer. The borohydride may be any compound set forth in WO 2018/075972, which published Apr. 26, 2018, and was filed as International PCT Patent Application No. PCT/US2017/057735, and is entitled ELECTROLYTE SEPARATORS INCLUDING LITHIUM BOROHYDRIDE AND COMPOSITE ELECTROLYTE SEPARATORS OF LITHIUM-STUFFED GARNET AND LITHIUM BOROHYDRIDE, the entire contents of which are incorporated by reference herein in their entirety for all purposes. The borohydride may be any compound set forth in WO2019078897A1, which published Apr. 25, 2019, and was filed as International PCT Patent Application No. PCT/US2017/057739, filed Oct. 20, 2017, and is entitled BOROHYDRIDE-SULFIDE INTERFACIAL LAYER IN ALL SOLID STATE BATTERY, the entire contents of which are incorporated by reference herein in their entirety for all purposes.

As used herein, the term “electrolyte,” refers to a material that allows ions, e.g., Li⁺, to conduct therethrough, but which does not allow electrons to conduct therethrough. Electrolytes are useful for electrically isolating the cathode and anodes of a secondary battery while allowing ions, e.g., Li⁺, to transmit through the electrolyte. Electrolytes are ionically conductive and electrically insulating material. Electrolytes are useful for electrically insulating the cathode and anode of a secondary battery while allowing for the conduction of ions, e.g., Li⁺, through the electrolyte.

As used here, the phrase “solid-state separator,” “thin film solid-state separator,” “thin solid-state separator,” “solid-state electrolyte separator,” “solid separator”, or the term “separator” are used interchangeably and refer to a material that conducts Li ions, that is substantially insulating to electrons (e.g., the lithium ion conductivity is at least 103 times, and often 106 times, greater than the electron conductivity), and which acts as a physical barrier or spacer between the cathode and anode electrodes in an electrochemical cell or a rechargeable battery. In one embodiment, the separator is a thin film garnet separator, for example, a lithium-stuffed garnet thin film. In one embodiment, the separator is a bare film or a film-on-foil film.

As used herein, “thin” means, when qualifying a solid-state separator, a thickness dimension less than 200 μm, sometimes less than 100 μm and in some cases between 0.1 μm and 60 μm, and in other cases between about 10 nm to about 100 μm; in other cases, about 1 μm, 10 μm, or 50 μm in thickness.

As used herein, a “thickness” by which a film is characterized refers to the shortest, perpendicular distance, or median shortest, perpendicular measured distance, between the top and bottom faces of a film. As used herein, the top and bottom faces refer to the sides of the film having the largest surface areas. As used herein, electrolyte separator or membrane thickness is measured by cross-sectional scanning electron microscopy.

As used herein the phrase “active electrode material,” or “active material,” refers to a material that is suitable for use as a Li rechargeable battery and which undergoes a chemical reaction during the charging and discharging cycles.

As used herein the term “making,” refers to the process or process of forming or causing to form the object that is made. For example, making an energy storage electrode includes the process, process steps, or process of causing the electrode of an energy storage device to be formed. The end result of the steps constituting the making of the energy storage electrode is the production of a material that is functional as an electrode.

As used herein, the phrase “electrochemical device” refers to an energy storage device, such as, but not limited to a Li-secondary battery that operates or produces electricity or an electrical current by an electrochemical reaction.

As used herein, the phrase “providing” refers to the provision of, generation or, presentation of, or delivery of that which is provided.

As used herein, the phrase “lithium-stuffed garnet” refers to films that are characterized by a crystal structure related to a garnet crystal structure. Lithium-stuffed garnets include compounds having the formula Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, V, W, Mo, Ta, Ga, or Sb and as described herein.

Garnets, as used herein, also include those garnets described above that are doped with Al₂O₃. Garnets, as used herein, also include those garnets described above that are doped so that Al³⁺ substitutes for Li. As used herein, lithium-stuffed garnets, and garnets, generally, include, but are not limited to, Li_{7.0}La₃(Zrₜ₁Nbₜ₂+Taₜ₃)O₁₂+0.35Al₂O₃; wherein (t1+t2+t3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples x is 7 and y is 1.0. In some examples x is 7 and y is 0.35. In some examples x is 7 and y is 0.7. In some examples x is 7 and y is 0.4. Also, garnets as used herein include, but are not limited to, LiₓLa₃Zr₂O₁₂+yAl₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the term “LZO” or “LLZO” refers to Li₇ZrO₃, ZrO₂, or a combination thereof.

A “bilayer” herein includes a ceramic layer deposited onto a metal layer. A sintered bilayer may have a ceramic layer thickness of 10 μm-50 μm and the metal layer thickness is 2 μm-20 μm thick. The bilayer may have a ceramic layer thickness of 20 μm-30 μm and the metal layer thickness is 3 μm-10 μm thick.

As used herein, a “Gurley number” is a value referring to the amount of time in seconds required for 100 cubic centimeters (cc) of air to pass through a one square inch sample of a material at a pressure differential of 1.21 kiloPascal (kPa). Gurley numbers are dependent on the thickness of the measured samples. The thickness of the samples measured herein range between about 50 μm and 150 μm.

As used herein, a “Poisson's ratio” refers to the deformation of a material as a result of an applied force. It is a ratio of the strain experienced by the material in a direction perpendicular to the applied force (i.e., transverse strain) to the strain experienced by the material in a direction of the applied force (i.e., longitudinal strain). The transverse strain is a measure of the change in the diameter of a cylinder of material to its original diameter due to a longitudinal force, and the longitudinal strain is a measure of the change in the thickness of the cylinder. The Poisson's ratios measured herein are measured as a result of an applied pressure of about 250 kPa to about 700 kPa at a temperature of about 110° C. to about 150° C.

### II. Electrochemical Stack

In a first aspect, the present disclosure provides an electrochemical stack that includes a) a solid-state cathode having two major surfaces, four minor surfaces, a first width and a first length, the solid-state cathode comprising a solid catholyte; b) a solid-state separator having a second width and a second length; c) a cathode current collector; d) a bonding layer; and e) a frame; wherein the frame surrounds the four minor surfaces of the solid-state cathode; wherein the frame is positioned between and contacts the cathode current collector and the solid-state separator; wherein the bonding layer is positioned between and contacts the solid-state cathode and the solid-state separator; and wherein the first width is smaller than the second width; and first length is smaller than the second length.

In some embodiments, including any of the foregoing, the electrochemical stack comprises a second solid-state cathode, a second solid-state separator, a second bonding layer, and a second frame. In some embodiments, the electrochemical stack comprises a double-sided solid-state cathode.

In some embodiments, including any of the foregoing, the frame is attached to the solid-state separator and the cathode current collector. In other embodiments, the frame is attached to the solid-state separator. In other embodiments, the frame is attached to the current collector.

In some embodiments, including any of the foregoing, the frame surrounds the four minor surfaces of the solid-state cathode and contacts all four minor surfaces. In some embodiments, the frame surrounds the four minor surfaces of the solid-state cathode and contacts at least one of the four minor surfaces. In other embodiments, the frame surrounds the four minor surfaces of the solid-state cathode and does not contact any of the four minor surfaces of the solid-state cathode. In some embodiments, there is an empty space in between at least one of the four minor surfaces of the solid-state cathode and the frame. In some embodiments, there is an empty space in between all four minor surfaces of the solid-state cathode and the frame.

In some embodiments, the frame comprises a thermoplastic polymer.

In some embodiments, including any of the foregoing, the frame comprises a modified thermoplastic polymer. In some embodiments, the modified thermoplastic polymer is a copolymer. In other embodiments, the modified thermoplastic polymer is a homopolymer of a modified monomer. In other embodiments, the modified thermoplastic polymer is a thermoplastic polymer with an additive that modifies the properties of the native polymer. In other embodiments, the modified thermoplastic polymer is a polymer that has been cross-linked. In other embodiments, the modified thermoplastic polymer is a polymer that has been functionalized with a functional group. In some embodiments, the functional group is selected from vinyl acetate, vinyl alcohol, a halide (such as chloride or fluoride), terephthalate, alkyl, propyl, acrylic acid, maleic anhydride, or combinations thereof.

In some embodiments, the thermoplastic polymer is selected from a polyethylene polymer, a polypropylene polymer, a polybutylene polymer, a polypentene polymer, a polystyrene polymer, a polyaryletherketone polymer, a polyimide polymer, a polyaryletherimide polymer, a polysulfone polymer, an acrylate polymer, a polycarbonate polymer, or combinations thereof.

In some embodiments, the polyimide polymer is a porous polyimide polymer. In some embodiments, the porous polyimide polymer has a porosity of about 60% to 80% by volume. In some embodiments, the porous polyimide polymer has a pore size of about 0.01 μm to about 2 μm, or about 0.01 μm to about 1 μm.

In some embodiments, the thermoplastic polymer is selected from a modified polyethylene polymer, a modified polypropylene polymer, a modified polybutylene polymer, a modified polypentene polymer, a modified polystyrene polymer, a modified polyaryletherketone polymer, a modified polyaryletherimide polymer, a modified polysulfone polymer, a modified acrylate polymer, a modified perfluoroelastomer polymer, a modified polycarbonate polymer, or combinations thereof.

In some embodiments, the thermoplastic polymer is selected from acrylonitrile butadiene styrene (ABS), ethylene-propylene rubber (EPM), ethylene propylene diene rubber (EPDM), fluorinated ethylene propylene (FEP), perfluoroelastomer (FFKM), polybutene-1 (PB-1), polycarbonate (PC), polyether ether ketone (PEEK), polyetherimide (PEI), polyether sulfone (PES), polyethylene terephthalate (PET), polyisobutylene (PIB), polyisoprene, poly(methyl methacrylate) (PMMA), polymethylpentene (PMP), polytetrafluoroethylene (PTFE), polyvinylidene difluoride (PVDF), polyvinylidene difluoride-co-fluoro ethylene propylene (PVDF-co-FEP), poly(styrene-isoprene-styrene) (SIS), poly(styrene-butadiene-styrene) (SBS), ultra-high molecular-weight polyethylene (UHWPE), or combinations thereof. In some embodiments, the thermoplastic polymer is acrylonitrile butadiene styrene (ABS). In some embodiments, the thermoplastic polymer is ethylene-propylene rubber (EPM). In some embodiments, the thermoplastic polymer is ethylene propylene diene rubber (EPDM). In some embodiments, the thermoplastic polymer is fluorinated ethylene propylene (FEP). In some embodiments, the thermoplastic polymer is perfluoroelastomer (FFKM). In some embodiments, the thermoplastic polymer is polybutene-1 (PB-1). In some embodiments, the thermoplastic polymer is polycarbonate (PC). In some embodiments, the thermoplastic polymer is polyether ether ketone (PEEK). In some embodiments, the thermoplastic polymer is polyetherimide (PEI). In some embodiments, the thermoplastic polymer is polyether sulfone (PES). In some embodiments, the thermoplastic polymer is polyethylene terephthalate (PET). In some embodiments, the thermoplastic polymer is polyisobutylene (PIB). In some embodiments, the thermoplastic polymer is polyisoprene. In some embodiments, the thermoplastic polymer is poly(methyl methacrylate) (PMMA). In some embodiments, the thermoplastic polymer is polymethylpentene (PMP). In some embodiments, the thermoplastic polymer is polytetrafluoroethylene (PTFE). In some embodiments, the thermoplastic polymer is polyvinylidene difluoride-co-fluoro ethylene propylene (PVDF-co-FEP). In some embodiments, the thermoplastic polymer is poly(styrene-isoprene-styrene) (SIS). In some embodiments, the thermoplastic polymer is poly(styrene-butadiene-styrene) (SBS). In some embodiments, the thermoplastic polymer is ultra-high molecular-weight polyethylene (UHWPE).

In some embodiments, including any of the foregoing, the modified thermoplastic polymer has a melting point in the range of about 50° C. to about 350° C. In some embodiments, the modified thermoplastic polymer has a melting point of about 80° C. to about 300° C. In some embodiments, the modified thermoplastic polymer has a melting point of about 80° C. to about 250° C. In some embodiments, the modified thermoplastic polymer has a melting point of about 100° C. to about 200° C. In some embodiments, the modified thermoplastic polymer has a melting point of about 110° C. to about 180° C. In some embodiments, the modified thermoplastic polymer has a melting point of about 120° C. to about 170° C. In some embodiments, the modified thermoplastic polymer has a melting point of about 130° C. to about 170° C. In some embodiments, the modified thermoplastic polymer has a melting point of about 140° C. to about 170° C. In some embodiments, the modified thermoplastic polymer has a melting point of about 150° C. to about 170° C. In some embodiments, the modified thermoplastic polymer has a melting point of about 150° C. to about 160° C.

In some embodiments, the modified thermoplastic polymer has a melting point of greater than 160° C.

In some embodiments, the modified thermoplastic polymer has a melting point in the range of about 160° C. to about 350° C. In some embodiments, the modified thermoplastic polymer has a melting point in the range of about 160° C. to about 300° C. In some embodiments, the modified thermoplastic polymer has a melting point in the range of about 160° C. to about 250° C. In some embodiments, the modified thermoplastic polymer has a melting point in the range of about 160° C. to about 200° C. In some embodiments, the modified thermoplastic polymer has a melting point in the range of about 160° C. to about 180° C. In some embodiments, the modified thermoplastic polymer has a melting point in the range of about 160° C. to about 170° C.

In some embodiments, the thermoplastic polymer has a Gurley number of about 1 second per 100 cubic centimeters (1 sec/100 cc) to about 50 sec/100 cc per 50 μm to 150 μm thick sample.

In some embodiments, the modified thermoplastic polymer has a weight average molecular weight (M_{w}). In some embodiments, the modified thermoplastic polymer has a weight average molecular weight (M_{w}) after being cross-linked.

In some embodiments, the modified thermoplastic polymer has a weight average molecular weight (M_{w}) of about 10,000 g/mol to about 500,000 g/mol. In some embodiments, the modified thermoplastic polymer has a weight average molecular weight (M_{w}) of about 10,000 g/mol to about 450,000 g/mol. In some embodiments, the modified thermoplastic polymer has a weight average molecular weight (M_{w}) of about 10,000 g/mol to about 400,000 g/mol. In some embodiments, the modified thermoplastic polymer has a weight average molecular weight (M_{w}) of about 10,000 g/mol to about 350,000 g/mol. In some embodiments, the modified thermoplastic polymer has a weight average molecular weight (M_{w}) of about 10,000 g/mol to about 300,000 g/mol. In some embodiments, the modified thermoplastic polymer has a weight average molecular weight (M_{w}) of about 10,000 g/mol to about 250,000 g/mol. In some embodiments, the modified thermoplastic polymer has a weight average molecular weight (M_{w}) of about 10,000 g/mol to about 200,000 g/mol. In some embodiments, the modified thermoplastic polymer has a weight average molecular weight (M_{w}) of about 30,000 g/mol to about 200,000 g/mol. In some embodiments, the modified thermoplastic polymer has a weight average molecular weight (M_{w}) of about 50,000 g/mol to about 200,000 g/mol. In some embodiments, the modified thermoplastic polymer has a weight average molecular weight (M_{w}) of about 100,000 g/mol to about 200,000 g/mol.

In some embodiments, the modified thermoplastic polymer has a weight average molecular weight (M_{w}) of about 20,000 g/mol to about 1,000,000 g/mol after being cross-linked.

In some embodiments, the modified polyethylene polymer is a vinyl acetate modified polyethylene polymer. In some embodiments, the modified polyethylene polymer is a vinyl alcohol modified polyethylene polymer. In some embodiments, the modified polyethylene polymer is a halide modified polyethylene polymer. In some embodiments, the modified polyethylene polymer is a chloride modified polyethylene polymer. In some embodiments, the modified polyethylene polymer is a fluoride modified polyethylene polymer. In some embodiments, the modified polyethylene polymer is an amide modified polyethylene polymer. In some embodiments, the modified polyethylene polymer is a terephthalate modified polyethylene polymer. In some embodiments, the modified polyethylene polymer is an alkyl modified polyethylene polymer. In some embodiments, the modified polyethylene polymer is a propyl modified polyethylene polymer. In some embodiments, the modified polyethylene polymer is an acrylic acid modified polyethylene polymer. In some embodiments, the modified polyethylene polymer is a maleic anhydride modified polyethylene polymer. In some embodiments, the modified polyethylene polymer is cross-linked. In other embodiments, the modified polyethylene polymer is not cross-linked.

In some embodiments, the modified polyethylene polymer is a maleic anhydride polyethylene copolymer.

In some embodiments, the modified polyethylene polymer is a cross-linked, maleic anhydride polyethylene copolymer.

In some embodiments, the modified polyethylene polymer has a melting point in the range of about 80° C. to about 300° C. In some embodiments, the modified polyethylene polymer has a melting point of about 80° C. to about 250° C. In some embodiments, the modified polyethylene polymer has a melting point of about 100° C. to about 200° C. In some embodiments, the modified polyethylene polymer has a melting point of about 110° C. to about 180° C. In some embodiments, the modified polyethylene polymer has a melting point of about 120° C. to about 170° C. In some embodiments, the modified polyethylene polymer has a melting point of about 130° C. to about 170° C. In some embodiments, the modified polyethylene polymer has a melting point of about 140° C. to about 170° C. In some embodiments, the modified polyethylene polymer has a melting point of about 150° C. to about 170° C. In some embodiments, the modified polyethylene polymer has a melting point of about 150° C. to about 160° C.

In some embodiments, the modified polyethylene polymer has a melting point of greater than 160° C.

In some embodiments, the modified polyethylene polymer has a melting point in the range of about 160° C. to about 350° C. In some embodiments, the modified polyethylene polymer has a melting point in the range of about 160° C. to about 300° C. In some embodiments, the modified polyethylene polymer has a melting point in the range of about 160° C. to about 250° C. In some embodiments, the modified polyethylene polymer has a melting point in the range of about 160° C. to about 200° C. In some embodiments, the modified polyethylene polymer has a melting point in the range of about 160° C. to about 180° C. In some embodiments, the modified polyethylene polymer has a melting point in the range of about 160° C. to about 170° C.

In some embodiments, the cross-linked, maleic anhydride polyethylene copolymer has a melting point of greater than about 160° C.

In some embodiments, the cross-linked, maleic anhydride polyethylene copolymer has a melting point in the range of about 160° C. to about 350° C. In some embodiments, the cross-linked, maleic anhydride polyethylene copolymer has a melting point in the range of about 160° C. to about 300° C. In some embodiments, cross-linked, maleic anhydride polyethylene copolymer has a melting point in the range of about 160° C. to about 250° C. In some embodiments, the cross-linked, maleic anhydride polyethylene copolymer has a melting point in the range of about 160° C. to about 200° C. In some embodiments, the cross-linked, maleic anhydride polyethylene copolymer has a melting point in the range of about 160° C. to about 180° C. In some embodiments, the cross-linked, maleic anhydride polyethylene copolymer has a melting point in the range of about 160° C. to about 170° C.

In some embodiments, the modified polypropylene polymer is a halide modified polypropylene polymer. In some embodiments, the modified polypropylene polymer is a chloride modified polypropylene polymer. In some embodiments, the modified polypropylene polymer is a fluoride modified polypropylene polymer. In some embodiments, the modified polypropylene polymer is an alkyl modified polypropylene polymer. In some embodiments, the modified polypropylene polymer is an ethylene modified polypropylene polymer. In other embodiments, the modified polypropylene polymer is a maleic anhydride modified polypropylene polymer.

In some embodiments, the frame comprises a first thermoplastic polymer and a second thermoplastic polymer. In some embodiments, the first thermoplastic polymer and the second thermoplastic polymer are different thermoplastic polymers.

In some embodiments, the first thermoplastic polymer is a modified polyethylene polymer. In some embodiments, the first thermoplastic polymer is a modified polyethylene polymer with a weight average molecular weight (M_{w}) of about 100,000 g/mol to about 200,000 g/mol. In some embodiments, the first thermoplastic polymer is a maleic anhydride modified polyethylene polymer. In some embodiments, the first thermoplastic polymer is a maleic anhydride modified polyethylene polymer with a weight average molecular weight (M_{w}) of about 100,000 g/mol to about 200,000 g/mol. In some embodiments, the first thermoplastic polymer is a cross-linked, maleic anhydride polyethylene copolymer.

In some embodiments, the second thermoplastic polymer is PTFE. In other embodiments, the second thermoplastic polymer is PEEK. In other embodiments, the second thermoplastic polymer is a polyimide polymer. In other embodiments, the second thermoplastic polymer is a porous polyimide polymer.

In some embodiments, the frame comprises one or more layers. In some embodiments, the frame comprises two or more layers. In some embodiments, the frame comprises three or more layers. In some embodiments, the frame comprises one or more layers wherein each layer comprises a thermoplastic polymer. In some embodiments, the frame comprises two or more layers wherein each layer comprises a thermoplastic polymer. In some embodiments, the frame comprises three or more layers wherein each layer comprises a thermoplastic polymer.

In some embodiments, the frame comprises a first layer and a second layer. In some embodiments, the first layer of the frame and the second layer of the frame comprise the same thermoplastic polymer. In other embodiments, the first layer of the frame and the second layer of the frame comprise different thermoplastic polymers.

In some embodiments, the frame comprises a first layer and a second layer, wherein the first layer comprises a modified polyethylene polymer.

In some embodiments, the frame comprises a first layer and a second layer, wherein the first layer comprises a modified polyethylene polymer with a weight average molecular weight (M_{w}) of about 100,000 g/mol to about 200,000 g/mol. In some embodiments, the first layer comprises a maleic anhydride modified polyethylene polymer. In some embodiments, the first layer comprises a maleic anhydride polyethylene copolymer. In other embodiments, the first layer comprises a maleic anhydride polyethylene copolymer with a weight average molecular weight (M_{w}) of about 100,000 g/mol to about 200,000 g/mol. In other embodiments, the first layer comprises a cross-linked, maleic anhydride polyethylene copolymer.

In some embodiments, the frame comprises a first layer and a second layer, wherein the second layer comprises a thermoplastic polymer with a Gurley number of about 1 sec/100 cc to about 50 sec/100 cc per 50 μm to 150 μm thick sample.

In some embodiments, the frame comprises a first layer and a second layer, wherein the second layer comprises PEEK. In other embodiments, the second layer comprises PTFE. In other embodiments, the second layer comprises a polyimide polymer. In other embodiments, the second layer comprises a porous polyimide polymer.

In some embodiments, the frame comprises a first layer and a second layer, wherein the second layer comprises PEEK with a Gurley number of about 1 sec/100 cc to about 50 sec/100 cc per 50 μm to 150 μm thick sample. In other embodiments, the second layer comprises PTFE with a Gurley number of about 1 sec/100 cc to about 50 sec/100 cc per 50 μm to 150 μm thick sample. In other embodiments, the second layer comprises a polyimide polymer with a Gurley number of about 1 sec/100 cc to about 50 sec/100 cc per 50 μm to 150 μm thick sample. In other embodiments, the second layer comprises a porous polyimide polymer with a Gurley number of about 1 sec/100 cc to about 50 sec/100 cc per 50 μm to 150 μm thick sample.

In some embodiments, the frame comprises a first layer and a second layer, wherein the first layer comprises a maleic anhydride polyethylene copolymer and the second layer comprises a thermoplastic polymer with a Gurley number of about 1 sec/100 cc to about 50 sec/100 cc per 50 μm to 150 μm thick sample. In some embodiments, the frame comprises a first layer and a second layer, wherein the first layer comprises a cross-linked, maleic anhydride polyethylene copolymer and the second layer comprises a thermoplastic polymer with a Gurley number of about 1 sec/100 cc to about 50 sec/100 cc per 50 μm to 150 μm thick sample.

In some embodiments, including any of the foregoing, the frame comprises a first layer and a second layer, wherein the first layer comprises a maleic anhydride polyethylene copolymer and the second layer comprises PEEK, PTFE, a polyimide polymer, or a porous polyimide polymer. In some embodiments, the frame comprises a first layer and a second layer, wherein the first layer comprises a cross-linked, maleic anhydride polyethylene copolymer and the second layer comprises PEEK, PTFE, a polyimide polymer, or a porous polyimide polymer.

In some embodiments, including any of the foregoing, the frame comprises a first layer and a second layer, wherein the first layer comprises a maleic anhydride polyethylene copolymer and the second layer comprises PEEK. In some embodiments, the frame comprises a first layer and a second layer, wherein the first layer comprises a cross-linked, maleic anhydride polyethylene copolymer and the second layer comprises PEEK. In some embodiments, the frame comprises a first layer and a second layer, wherein the first layer comprises a maleic anhydride polyethylene copolymer and the second layer comprises PTFE. In some embodiments, the frame comprises a first layer and a second layer, wherein the first layer comprises a cross-linked, maleic anhydride polyethylene copolymer and the second layer comprises PTFE. In some embodiments, the frame comprises a first layer and a second layer, wherein the first layer comprises a maleic anhydride polyethylene copolymer and the second layer comprises a polyimide polymer. In some embodiments, the frame comprises a first layer and a second layer, wherein the first layer comprises a cross-linked, maleic anhydride polyethylene copolymer and the second layer comprises a polyimide polymer. In some embodiments, the frame comprises a first layer and a second layer, wherein the first layer comprises a maleic anhydride polyethylene copolymer and the second layer comprises a porous polyimide polymer. In some embodiments, the frame comprises a first layer and a second layer, wherein the first layer comprises a cross-linked, maleic anhydride polyethylene copolymer and the second layer comprises a porous polyimide polymer.

In some embodiments, including any of the foregoing, the frame comprises a first layer and a second layer, wherein the first layer comprises a maleic anhydride polyethylene copolymer and the second layer comprises PEEK with a Gurley number of about 1 sec/100 cc to about 50 sec/100 cc per 50 μm to 150 μm thick sample. In some embodiments, the frame comprises a first layer and a second layer, wherein the first layer comprises a cross-linked, maleic anhydride polyethylene copolymer and the second layer comprises PEEK with a Gurley number of about 1 sec/100 cc to about 50 sec/100 cc per 50 μm to 150 μm thick sample. In some embodiments, the frame comprises a first layer and a second layer, wherein the first layer comprises a maleic anhydride polyethylene copolymer and the second layer comprises PTFE with a Gurley number of about 1 sec/100 cc to about 50 sec/100 cc per 50 μm to 150 μm thick sample. In some embodiments, the frame comprises a first layer and a second layer, wherein the first layer comprises a cross-linked, maleic anhydride polyethylene copolymer and the second layer comprises PTFE with a Gurley number of about 1 sec/100 cc to about 50 sec/100 cc per 50 μm to 150 μm thick sample. In some embodiments, the frame comprises a first layer and a second layer, wherein the first layer comprises a maleic anhydride polyethylene copolymer and the second layer comprises a polyimide polymer with a Gurley number of about 1 sec/100 cc to about 50 sec/100 cc per 50 μm to 150 μm thick sample. In some embodiments, the frame comprises a first layer and a second layer, wherein the first layer comprises a cross-linked, maleic anhydride polyethylene copolymer and the second layer comprises a polyimide polymer with a Gurley number of about 1 sec/100 cc to about 50 sec/100 cc per 50 μm to 150 μm thick sample. In some embodiments, the frame comprises a first layer and a second layer, wherein the first layer comprises a maleic anhydride polyethylene copolymer and the second layer comprises a porous polyimide polymer with a Gurley number of about 1 sec/100 cc to about 50 sec/100 cc per 50 μm to 150 μm thick sample. In some embodiments, the frame comprises a first layer and a second layer, wherein the first layer comprises a cross-linked, maleic anhydride polyethylene copolymer and the second layer comprises a porous polyimide polymer with a Gurley number of about 1 sec/100 cc to about 50 sec/100 cc per 50 μm to 150 μm thick sample.

In some embodiments, the frame comprises a first layer and a second layer, wherein the first layer contacts the cathode current collector. In some embodiments, the frame comprises a first layer and a second layer, wherein the second layer contacts the solid-state separator. In some embodiments, the frame comprises a first layer and a second layer, wherein the first layer contacts the cathode current collector and the second layer contacts the solid-state separator.

In some embodiments, the frame comprises a first layer and a second layer, wherein the first layer comprises a cross-linked, maleic anhydride polyethylene copolymer that contacts the cathode current collector. In some embodiments, the frame comprises a first layer and a second layer, wherein the first layer comprises a cross-linked, maleic anhydride polyethylene copolymer that contacts the cathode current collector.

In some embodiments, the frame comprises a first layer and a second layer, wherein the first layer comprises a cross-linked, maleic anhydride polyethylene copolymer that contacts the cathode current collector, and wherein the second layer comprises PEEK that contacts the solid-state separator. In some embodiments, the frame comprises a first layer and a second layer, wherein the first layer comprises a cross-linked, maleic anhydride polyethylene copolymer that contacts the cathode current collector, and wherein the second layer comprises PTFE that contacts the solid-state separator. In some embodiments, the frame comprises a first layer and a second layer, wherein the first layer comprises a cross-linked, maleic anhydride polyethylene copolymer that contacts the cathode current collector, and wherein the second layer comprises a polyimide polymer that contacts the solid-state separator. In some embodiments, the frame comprises a first layer and a second layer, wherein the first layer comprises a cross-linked, maleic anhydride polyethylene copolymer that contacts the cathode current collector, and wherein the second layer comprises a porous polyimide polymer that contacts the solid-state separator.

In some embodiments, the frame comprises a first layer and a second layer, wherein the second layer comprises a thermoplastic polymer with a Gurley number of about 1 sec/100 cc to about 50 sec/100 cc per 50 μm to 150 μm thick sample that contacts the solid-state separator. In some embodiments, the frame comprises a first layer and a second layer, wherein the first layer comprises a cross-linked, maleic anhydride polyethylene copolymer that contacts the cathode current collector, and wherein the second layer comprises a thermoplastic polymer with a Gurley number of about 1 sec/100 cc to about 50 sec/100 cc per 50 μm to 150 μm thick sample that contacts the solid-state separator.

In some embodiments, the frame comprises a first layer, a second layer, and a third layer. In some embodiments, the first layer, second layer, and third layer each comprise a thermoplastic polymer. In some embodiments, the first layer of the frame and the third layer of the frame comprise the same thermoplastic polymer. In some embodiments, the first layer of the frame and the third layer of the frame comprise different thermoplastic polymers. In some embodiments, the second layer comprises a different thermoplastic polymer than the first layer and the third layer. In some embodiments, the second layer comprises the same thermoplastic polymer as the first layer and the third layer. In some embodiments, the second layer comprises the same thermoplastic polymer as the first layer and a different thermoplastic polymer than the third layer. In some embodiments, the second layer comprises the same thermoplastic polymer as the third layer and a different thermoplastic polymer than the first layer.

In some embodiments, the frame comprises a first layer, a second layer, and a third layer, wherein the first layer comprises a modified polyethylene polymer. In some embodiments, the third layer comprises a modified polyethylene polymer. In some embodiments, the first layer and the third layer separately comprise a modified polyethylene polymer, wherein the modified polyethylene polymer of the first layer is the same as the modified polyethylene polymer of the third layer. In some embodiments, the first layer and the third layer separately comprise a modified polyethylene polymer, wherein the modified polyethylene polymer of the first layer is different than the modified polyethylene polymer of the third layer.

In some embodiments, the frame comprises a first layer, a second layer, and a third layer, wherein the first layer comprises a modified polyethylene polymer with a weight average molecular weight (M_{w}) of about 100,000 g/mol to about 200,000 g/mol. In some embodiments, the first layer comprises a maleic anhydride modified polyethylene polymer. In other embodiments, the first layer comprises a maleic anhydride modified polyethylene polymer with a weight average molecular weight (M_{w}) of about 100,000 g/mol to about 200,000 g/mol. In other embodiments, the first layer comprises a maleic anhydride polyethylene copolymer. In other embodiments, the first layer comprises a maleic anhydride polyethylene copolymer with a weight average molecular weight (M_{w}) of about 100,000 g/mol to about 200,000 g/mol. In other embodiments, the first layer comprises a cross-linked, maleic anhydride polyethylene copolymer. In some embodiments, the third layer comprises a modified polyethylene polymer with a weight average molecular weight (M_{w}) of about 100,000 g/mol to about 200,000 g/mol. In some embodiments, the third layer comprises a maleic anhydride modified polyethylene polymer. In other embodiments, the third layer comprises a maleic anhydride modified polyethylene polymer with a weight average molecular weight (M_{w}) of about 100,000 g/mol to about 100,000 g/mol. In other embodiments, the third layer comprises a maleic anhydride polyethylene copolymer. In other embodiments, the third layer comprises a maleic anhydride polyethylene copolymer with a weight average molecular weight (M_{w}) of about 100,000 g/mol to about 200,000 g/mol. In other embodiments, the third layer comprises a cross-linked, maleic anhydride polyethylene copolymer. In other embodiments, the first layer and the third layer each comprise a maleic anhydride modified polyethylene polymer. In other embodiments, the first layer and the third layer each comprise a maleic anhydride modified polyethylene polymer with a weight average molecular weight (M_{w}) of about 100,000 g/mol to about 200,000 g/mol. In other embodiments, the first layer and the third layer each comprise a maleic anhydride polyethylene copolymer. In other embodiments, the first layer and the third layer each comprise a maleic anhydride polyethylene copolymer with a weight average molecular weight (M_{w}) of about 100,000 g/mol to about 200,000 g/mol. In other embodiments, the first layer and the third layer each comprise a cross-linked, maleic anhydride polyethylene copolymer.

In some embodiments, the frame comprises a first layer, a second layer, and a third layer, wherein the second layer comprises a thermoplastic polymer with a Gurley number of about 1 sec/100 cc to about 50 sec/100 cc per 50 μm to 150 μm thick sample.

In some embodiments, the frame comprises a first layer, a second layer, and a third layer, wherein the second layer comprises PEEK. In other embodiments, the second layer comprises PTFE. In other embodiments, the second layer comprises a polyimide polymer. In other embodiments, the second layer comprises a porous polyimide polymer.

In some embodiments, the frame comprises a first layer, a second layer, and a third layer, wherein the second layer comprises PEEK with a Gurley number of about 1 sec/100 cc to about 50 sec/100 cc per 50 μm to 150 μm thick sample. In some embodiments, the frame comprises a first layer, a second layer, and a third layer, wherein the second layer comprises PTFE with a Gurley number of about 1 sec/100 cc to about 50 sec/100 cc per 50 μm to 150 μm thick sample. In other embodiments, the second layer comprises a polyimide polymer with a Gurley number of about 1 sec/100 cc to about 50 sec/100 cc per 50 μm to 150 μm thick sample. In other embodiments, the second layer comprises a porous polyimide polymer with a Gurley number of about 1 sec/100 cc to about 50 sec/100 cc per 50 μm to 150 μm thick sample.

In some embodiments, the frame comprises a first layer, a second layer, and a third layer, wherein the first layer and third layer each comprise a modified polyethylene polymer with a weight average molecular weight (M_{w}) of about 100,000 g/mol to about 200,000 g/mol, and wherein the second layer comprises PEEK. In some embodiments, the frame comprises a first layer, a second layer, and a third layer, wherein the first layer and third layer each comprise a modified polyethylene polymer with a weight average molecular weight (M_{w}) of about 100,000 g/mol to about 200,000 g/mol, and wherein the second layer comprises PTFE. In some embodiments, the frame comprises a first layer, a second layer, and a third layer, wherein the first layer and third layer each comprise a maleic anhydride modified polyethylene polymer, and wherein the second layer comprises PEEK. In some embodiments, the frame comprises a first layer, a second layer, and a third layer, wherein the first layer and third layer each comprise a maleic anhydride modified polyethylene polymer, and wherein the second layer comprises PTFE. In some embodiments, the frame comprises a first layer, a second layer, and a third layer, wherein the first layer and third layer each comprise a maleic anhydride modified polyethylene polymer with a weight average molecular weight (M_{w}) of about 100,000 g/mol to about 200,000 g/mol, and wherein the second layer comprises PEEK. In some embodiments, the frame comprises a first layer, a second layer, and a third layer, wherein the first layer and third layer each comprise a maleic anhydride modified polyethylene polymer with a weight average molecular weight (M_{w}) of about 100,000 g/mol to about 200,000 g/mol, and wherein the second layer comprises PTFE. In some embodiments, the frame comprises a first layer, a second layer, and a third layer, wherein the first layer and third layer each comprise a maleic anhydride polyethylene copolymer, and wherein the second layer comprises PEEK. In some embodiments, the frame comprises a first layer, a second layer, and a third layer, wherein the first layer and third layer each comprise a cross-linked, maleic anhydride polyethylene copolymer, and wherein the second layer comprises PEEK. In some embodiments, the frame comprises a first layer, a second layer, and a third layer, wherein the first layer and third layer each comprise a maleic anhydride polyethylene copolymer, and wherein the second layer comprises PTFE. In some embodiments, the frame comprises a first layer, a second layer, and a third layer, wherein the first layer and third layer each comprise a cross-linked, maleic anhydride polyethylene copolymer, and wherein the second layer comprises PTFE. In some embodiments, the frame comprises a first layer, a second layer, and a third layer, wherein the first layer and third layer each comprise a maleic anhydride polyethylene copolymer, and wherein the second layer comprises a polyimide polymer. In some embodiments, the frame comprises a first layer, a second layer, and a third layer, wherein the first layer and third layer each comprise a cross-linked, maleic anhydride polyethylene copolymer, and wherein the second layer comprises a polyimide polymer.

In some embodiments, the frame comprises a first layer, a second layer, and a third layer, wherein the first layer and third layer each comprise a maleic anhydride polyethylene copolymer, and wherein the second layer comprises PEEK, PTFE, a polyimide polymer, or a porous polyimide polymer. In some embodiments, the frame comprises a first layer, a second layer, and a third layer, wherein the first layer and third layer each comprise a cross-linked, maleic anhydride polyethylene copolymer, and wherein the second layer comprises PEEK, PTFE, a polyimide polymer, or a porous polyimide polymer.

In some embodiments, including any of the foregoing, the frame comprises a first layer, a second layer, and a third layer, wherein the first layer and third layer each comprise a maleic anhydride polyethylene copolymer, and wherein the second layer comprises PEEK with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a cross-linked, maleic anhydride polyethylene copolymer, and wherein the second layer comprises PEEK with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a maleic anhydride polyethylene copolymer, and wherein the second layer comprises PTFE with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a cross-linked, maleic anhydride polyethylene copolymer, and wherein the second layer comprises PTFE with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a maleic anhydride polyethylene copolymer, and wherein the second layer comprises a polyimide polymer with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a cross-linked, maleic anhydride polyethylene copolymer, and wherein the second layer comprises a polyimide polymer with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a maleic anhydride polyethylene copolymer, and wherein the second layer comprises a porous polyimide polymer with a Gurley number of about 1 sec/100 cc to about 50 sec/100 cc per 50 μm to 150 μm thick sample. In some embodiments, the frame comprises a first layer, a second layer, and a third layer, wherein the first layer and third layer each comprise a cross-linked, maleic anhydride polyethylene copolymer, and wherein the second layer comprises a porous polyimide polymer with a Gurley number of about 1 sec/100 cc to about 50 sec/100 cc per 50 μm to 150 μm thick sample.

In some embodiments, the frame comprises a first layer, a second layer, and a third layer, wherein the first layer or the third layer contacts the cathode current collector, and the remaining layer contacts the solid-state separator.

In some embodiments, the frame comprises a first layer, a second layer, and a third layer, wherein the first layer and third layer each comprise a cross-linked, maleic anhydride polyethylene copolymer, and wherein the first layer or the third layer contacts the cathode current collector, and the remaining layer contacts the solid-state separator.

In some embodiments, the thermoplastic polymer comprises initial dimensions (i.e., initial length, initial width, initial height) prior to heating or pressure application. In some embodiments, the thermoplastic polymer comprises initial dimensions prior to heating and pressure application. In some embodiments, the thermoplastic polymer comprises final dimensions (i.e., final length, final width, final height) after heating or pressure application. In some embodiments, the thermoplastic polymer comprises final dimensions after heating and pressure application.

In some embodiments, the thermoplastic polymer has a Poisson's ratio of about 0.2 to 0.3. In some embodiments, the thermoplastic polymer has a Poisson's ratio of about 0.2 to 0.3 at a temperature of about 110° C. to about 150° C. In some embodiments, the thermoplastic polymer has a Poisson's ratio of about 0.2 to 0.3 at an applied pressure of about 250 kPa to about 700 kPa. In some embodiments, the thermoplastic polymer has a Poisson's ratio of about 0.2 to 0.3 at a temperature of about 110° C. to about 150° C. and an applied pressure of about 250 kPa to about 700 kPa.

In some embodiments, the thermoplastic polymer has a lateral strain of less than about 1.5% at a temperature of about 110° C. to about 150° C. and at an applied pressure of about 250 kPa to about 700 kPa.

In some embodiments, the thermoplastic polymer does not shrink or expand by more than 10% with respect to the initial dimensions after heating to a temperature of about 80° C. to about 160° C. In some embodiments, the thermoplastic polymer does not shrink or expand by more than 9% with respect to the initial dimensions after heating to a temperature of about 80° C. to about 160° C. In some embodiments, the thermoplastic polymer does not shrink or expand by more than 8% with respect to the initial dimensions after heating to a temperature of about 80° C. to about 160° C. In some embodiments, the thermoplastic polymer does not shrink or expand by more than 7% with respect to the initial dimensions after heating to a temperature of about 80° C. to about 160° C. In some embodiments, the thermoplastic polymer does not shrink or expand by more than 6% with respect to the initial dimensions after heating to a temperature of about 80° C. to about 160° C. In some embodiments, the thermoplastic polymer does not shrink or expand by more than 5% with respect to the initial dimensions after heating to a temperature of about 80° C. to about 160° C. In some embodiments, the thermoplastic polymer does not shrink or expand by more than 4% with respect to the initial dimensions after heating to a temperature of about 80° C. to about 160° C. In some embodiments, the thermoplastic polymer does not shrink or expand by more than 3% with respect to the initial dimensions after heating to a temperature of about 80° C. to about 160° C. In some embodiments, the thermoplastic polymer does not shrink or expand by more than 2% with respect to the initial dimensions after heating to a temperature of about 80° C. to about 160° C. In some embodiments, the thermoplastic polymer does not shrink or expand by more than 1.5% with respect to the initial dimensions after heating to a temperature of about 80° C. to about 160° C. In some embodiments, the thermoplastic polymer does not shrink or expand by more than 1% with respect to the initial dimensions after heating to a temperature of about 80° C. to about 160° C. In some embodiments, the thermoplastic polymer does not shrink or expand by more than 0.5% with respect to the initial dimensions after heating to a temperature of about 80° C. to about 160° C.

In some embodiments, the thermoplastic polymer does not shrink or expand by more than 10% with respect to the initial dimensions after pressure application. In some embodiments, the thermoplastic polymer does not shrink or expand by more than 9% with respect to the initial dimensions after pressure application. In some embodiments, the thermoplastic polymer does not shrink or expand by more than 8% with respect to the initial dimensions after pressure application. In some embodiments, the thermoplastic polymer does not shrink or expand by more than 7% with respect to the initial dimensions after pressure application. In some embodiments, the thermoplastic polymer does not shrink or expand by more than 6% with respect to the initial dimensions after pressure application. In some embodiments, the thermoplastic polymer does not shrink or expand by more than 5% with respect to the initial dimensions after pressure application. In some embodiments, the thermoplastic polymer does not shrink or expand by more than 4% with respect to the initial dimensions after pressure application. In some embodiments, the thermoplastic polymer does not shrink or expand by more than 3% with respect to the initial dimensions after pressure application. In some embodiments, the thermoplastic polymer does not shrink or expand by more than 2% with respect to the initial dimensions after pressure application. In some embodiments, the thermoplastic polymer does not shrink or expand by more than 1.5% with respect to the initial dimensions after pressure application. In some embodiments, the thermoplastic polymer does not shrink or expand by more than 1% with respect to the initial dimensions after pressure application. In some embodiments, the thermoplastic polymer does not shrink or expand by more than 0.5% with respect to the initial dimensions after pressure application.

In some embodiments, the thermoplastic polymer does not shrink or expand by more than 10% with respect to the initial dimensions after heating to a temperature of about 80° C. to about 160° C. and pressure application. In some embodiments, the thermoplastic polymer does not shrink or expand by more than 9% with respect to the initial dimensions after heating to a temperature of about 80° C. to about 160° C. and pressure application. In some embodiments, the thermoplastic polymer does not shrink or expand by more than 8% with respect to the initial dimensions after heating to a temperature of about 80° C. to about 160° C. and pressure application. In some embodiments, the thermoplastic polymer does not shrink or expand by more than 7% with respect to the initial dimensions after heating to a temperature of about 80° C. to about 160° C. and pressure application. In some embodiments, the thermoplastic polymer does not shrink or expand by more than 6% with respect to the initial dimensions after heating to a temperature of about 80° C. to about 160° C. and pressure application. In some embodiments, the thermoplastic polymer does not shrink or expand by more than 5% with respect to the initial dimensions after heating to a temperature of about 80° C. to about 160° C. and pressure application. In some embodiments, the thermoplastic polymer does not shrink or expand by more than 4% with respect to the initial dimensions after heating to a temperature of about 80° C. to about 160° C. and pressure application. In some embodiments, the thermoplastic polymer does not shrink or expand by more than 3% with respect to the initial dimensions after heating to a temperature of about 80° C. to about 160° C. and pressure application. In some embodiments, the thermoplastic polymer does not shrink or expand by more than 2% with respect to the initial dimensions after heating to a temperature of about 80° C. to about 160° C. and pressure application. In some embodiments, the thermoplastic polymer does not shrink or expand by more than 1.5% with respect to the initial dimensions after heating to a temperature of about 80° C. to about 160° C. and pressure application. In some embodiments, the thermoplastic polymer does not shrink or expand by more than 1% with respect to the initial dimensions after heating to a temperature of about 80° C. to about 160° C. and pressure application. In some embodiments, the thermoplastic polymer does not shrink or expand by more than 0.5% with respect to the initial dimensions after heating to a temperature of about 80° C. to about 160° C. and pressure application.

In some embodiments, including any of the foregoing, the frame comprises one or more layers, wherein each of the one or more individual layers of the frame has a thickness, wherein the sum of the thicknesses of all layers is a total thickness of the frame. In some embodiments, the frame comprises two or more layers, wherein each of the two or more individual layers of the frame has a thickness, wherein the sum of the thicknesses of all layers is a total thickness of the frame. In some embodiments, the frame comprises three or more layers, wherein each of the three or more individual layers of the frame has a thickness, wherein the sum of the thicknesses of all layers is a total thickness of the frame.

In some embodiments, the total thickness of the frame is about 80 μm to about 200 μm. In some embodiments, the total thickness of the frame is about 80 μm to about 180 μm. In some embodiments, the total thickness of the frame is about 90 μm to about 160 μm. In some embodiments, the total thickness of the frame is about 100 μm to about 140 μm. In some embodiments, the total thickness of the frame is about 100 μm to about 130 μm. In some embodiments, the total thickness of the frame is about 110 μm to about 130 μm.

In some embodiments, the total thickness of the frame is larger than the thickness of the solid-state cathode.

In some embodiments, the thickness of the solid-state cathode is about 80 μm to about 180 μm. In some embodiments, the thickness of the solid-state cathode is about 80 μm to about 170 μm. In some embodiments, the thickness of the solid-state cathode is about 90 μm to about 170 μm. In some embodiments, the thickness of the solid-state cathode is about 100 μm to about 170 μm. In some embodiments, the thickness of the solid-state cathode is about 100 μm to about 160 μm.

In some embodiments, the frame comprises a first layer and a second layer, wherein the first layer and the second layer have a different thickness. In some embodiments, the first layer has a thickness of about 10 μm to about 60 μm. In some embodiments, the first layer has a thickness of about 10 μm to about 50 μm. In some embodiments, the first layer has a thickness of about 20 μm to about 50 μm.

In some embodiments, the frame comprises a first layer and a second layer, wherein the second layer has a thickness larger than the thickness of the first layer.

In some embodiments, the frame comprises a first layer and a second layer, wherein the thickness of the second layer is about 50% to about 90% of the total thickness of the frame. In some embodiments, the frame comprises a first layer and a second layer, wherein the thickness of the second layer is about 50% to about 85% of the total thickness of the frame. In some embodiments, the frame comprises a first layer and a second layer, wherein the thickness of the second layer is about 50% to about 80% of the total thickness of the frame. In some embodiments, the frame comprises a first layer and a second layer, wherein the thickness of the second layer is about 55% to 80% of the total thickness of the frame. In some embodiments, the frame comprises a first layer and a second layer, wherein the thickness of the second layer is about 55% to about 75% of the total thickness of the frame. In some embodiments, the frame comprises a first layer and a second layer, wherein the thickness of the second layer is about 60% to about 75% of the total thickness of the frame. In some embodiments, the frame comprises a first layer and a second layer, wherein the thickness of the second layer is about 60% to about 70% of the total thickness of the frame.

In some embodiments, the frame comprises a first layer and a second layer, wherein the thickness of the second layer is about 20 μm to about 140 μm. In some embodiments, the frame comprises a first layer and a second layer, wherein the thickness of the second layer is about 20 μm to about 130 μm. In some embodiments, the frame comprises a first layer and a second layer, wherein the thickness of the second layer is about 20 μm to about 120 μm. In some embodiments, the frame comprises a first layer and a second layer, wherein the thickness of the second layer is about 20 μm to about 110 μm. In some embodiments, the frame comprises a first layer and a second layer, wherein the thickness of the second layer is about 30 μm to about 110 μm. In some embodiments, the frame comprises a first layer and a second layer, wherein the thickness of the second layer is about 30 μm to about 100 μm. In some embodiments, the frame comprises a first layer and a second layer, wherein the thickness of the second layer is about 30 μm to about 90 μm. In some embodiments, the frame comprises a first layer and a second layer, wherein the thickness of the second layer is about 40 μm to about 80 μm. In some embodiments, the frame comprises a first layer and a second layer, wherein the thickness of the second layer is about 60 μm to about 80 μm.

In some embodiments, the frame comprises a first layer, a second layer, and a third layer, wherein the first layer and the third layer have a different thickness. In some embodiments, the first layer has a thickness of about 10 μm to about 50 μm. In some embodiments, the first layer has a thickness of about 20 μm to about 40 μm. In some embodiments, the third layer has a thickness of about 20 μm to about 60 μm. In some embodiments, the third layer has a thickness of about 20 μm to about 50 μm.

In some embodiments, the frame comprises a first layer, a second layer, and a third layer, wherein the first layer and the third layer have the same thickness. In some embodiments, the first layer and the third layer each have a thickness of about 10 μm to about 60 μm. In some embodiments, the first layer and the third layer each have a thickness of about 10 μm to about 50 μm. In some embodiments, the first layer and the third layer each have a thickness of about 20 μm to about 40 μm.

In some embodiments, the frame comprises a first layer, a second layer, and a third layer, wherein the second layer has a thickness larger than the thickness of the first layer or the thickness of the third layer. In some embodiments, the frame comprises a first layer, a second layer, and a third layer, wherein the second layer has a thickness larger than the thickness of the first layer and, separately, the thickness of the third layer.

In some embodiments, the frame comprises a first layer, a second layer, and a third layer, wherein the thickness of the second layer is about 30% to about 70% of the total thickness of the frame. In some embodiments, the frame comprises a first layer, a second layer, and a third layer, wherein the thickness of the second layer is about 35% to about 65% of the total thickness of the frame. In some embodiments, the frame comprises a first layer, a second layer, and a third layer, wherein the thickness of the second layer is about 35% to about 60% of the total thickness of the frame. In some embodiments, the frame comprises a first layer, a second layer, and a third layer, wherein the thickness of the second layer is about 35% to about 55% of the total thickness of the frame. In some embodiments, the frame comprises a first layer, a second layer, and a third layer, wherein the thickness of the second layer is about 40% to about 55% of the total thickness of the frame. In some embodiments, the frame comprises a first layer, a second layer, and a third layer, wherein the thickness of the second layer is about 40% to about 50% of the total thickness of the frame. In some embodiments, the frame comprises a first layer, a second layer, and a third layer, wherein the thickness of the second layer is about 45% to about 50% of the total thickness of the frame.

In some embodiments, the frame comprises a first layer, a second layer, and a third layer, wherein the thickness of the second layer is about 20 μm to about 140 μm. In some embodiments, the frame comprises a first layer, a second layer, and a third layer, wherein the thickness of the second layer is about 20 μm to about 130 μm. In some embodiments, the frame comprises a first layer, a second layer, and a third layer, wherein the thickness of the second layer is about 20 μm to about 120 μm. In some embodiments, the frame comprises a first layer, a second layer, and a third layer, wherein the thickness of the second layer is about 20 μm to about 110 μm. In some embodiments, the frame comprises a first layer, a second layer, and a third layer, wherein the thickness of the second layer is about 30 μm to about 110 μm. In some embodiments, the frame comprises a first layer, a second layer, and a third layer, wherein the thickness of the second layer is about 30 μm to about 100 μm. In some embodiments, the frame comprises a first layer, a second layer, and a third layer, wherein the thickness of the second layer is about 30 μm to about 90 μm. In some embodiments, the frame comprises a first layer, a second layer, and a third layer, wherein the thickness of the second layer is about 40 μm to about 80 μm. In some embodiments, the frame comprises a first layer, a second layer, and a third layer, wherein the thickness of the second layer is about 60 μm to about 80 μm. In some embodiments, the frame comprises a first layer, a second layer, and a third layer, wherein the thickness of the second layer is about 50 μm to about 70 μm.

In some embodiments, the frame is permeable to gas. In some embodiments, the frame is impermeable to moisture. In some embodiments, the frame is permeable to gas and impermeable to moisture. In some embodiments, the frame is permeable to H₂S, SO₂, NH₃, Ar, N₂, O₂, H₂ or combinations thereof.

In some embodiments, the frame comprises an outer frame length and an outer frame width. In some embodiments, the frame further comprises an inner frame length and an inner frame width.

In some embodiments, the outer frame length is about 70 mm to about 95 mm. In some embodiments, the outer frame length is about 70 mm to about 90 mm. In some embodiments, the outer frame length is about 70 mm to about 85 mm. In some embodiments, the outer frame length is about 70 mm to about 80 mm.

In some embodiments, the outer frame width is about 55 mm to about 80 mm. In some embodiments, the outer frame width is about 55 mm to 7 about 5 mm. In some embodiments, the outer frame width is about 55 mm to about 70 mm. In some embodiments, the outer frame width is about 55 mm to about 65 mm.

In some embodiments, the inner frame length is about 60 mm to about 85 mm. In some embodiments, the inner frame length is about 60 mm to about 80 mm. In some embodiments, the inner frame length is about 60 mm to about 75 mm. In some embodiments, the inner frame length is about 60 mm to about 70 mm.

In some embodiments, the inner frame width is about 45 mm to about 70 mm. In some embodiments, the inner frame width is about 45 mm to about 65 mm. In some embodiments, the inner frame width is about 45 mm to about 60 mm. In some embodiments, the inner frame width is about 45 mm to about 55 mm.

In some embodiments, the difference between the outer frame length and the inner frame length is about 5 mm to about 35 mm. In some embodiments, the difference between the outer frame length and the inner frame length is about 5 mm to about 30 mm. In some embodiments, the difference between the outer frame length and the inner frame length is about 5 mm to about 25 mm. In some embodiments, the difference between the outer frame length and the inner frame length is about 5 mm to about 20 mm. In some embodiments, the difference between the outer frame length and the inner frame length is about 5 mm to about 15 mm.

In some embodiments, the difference between the outer frame width and the inner frame width is about 5 mm to about 35 mm. In some embodiments, the difference between the outer frame width and the inner frame width is about 5 mm to about 30 mm. In some embodiments, the difference between the outer frame width and the inner frame width is about 5 mm to about 25 mm. In some embodiments, the difference between the outer frame width and the inner frame width is about 5 mm to about 20 mm. In some embodiments, the difference between the outer frame width and the inner frame width is about 5 mm to about 15 mm.

In some embodiments, the solid-state cathode width is about 45 mm to about 65 mm. In some embodiments, the solid-state cathode width is about 50 mm to about 65 mm. In some embodiments, the solid-state cathode width is about 50 mm to about 60 mm.

In some embodiments, the solid-state cathode length is about 60 mm to about 80 mm. In some embodiments, the solid-state cathode length is about 60 mm to about 75 mm. In some embodiments, the solid-state cathode length is about 65 mm to about 75 mm.

In some embodiments, the inner frame width is larger than the solid-state cathode width by at least about 20 μm, by at least about 100 μm, by at least about 500 μm, by at least about 1 mm, or by at least about 2 mm. In some embodiments, the inner frame width is larger than the solid-state cathode width by about 20 μm to about 5 mm. In some embodiments, the inner frame width is larger than the solid-state cathode width by about 20 μm to about 2.5 mm. In some embodiments, the inner frame width is larger than the solid-state cathode width by about 20 μm to about 2 mm. In some embodiments, the inner frame width is larger than the solid-state cathode width by about 50 μm to about 2 mm. In some embodiments, the inner frame width is larger than the solid-state cathode width by about 100 μm to about 2 mm. In some embodiments, the inner frame width is larger than the solid-state cathode width by about 200 μm to about 1.5 mm. In some embodiments, the inner frame width is larger than the solid-state cathode width by about 300 μm to about 1.5 mm. In some embodiments, the inner frame width is larger than the solid-state cathode width by about 400 μm to about 1.2 μm.

In some embodiments, the inner frame length is larger than the solid-state cathode length by at least about 20 μm, by at least about 100 μm, by at least about 500 μm, by at least about 1 mm, or by at least about 2 mm. In some embodiments, the inner frame length is larger than the solid-state cathode length by about 20 μm to about 5 mm. In some embodiments, the inner frame length is larger than the solid-state cathode length by about 20 μm to about 2.5 mm. In some embodiments, the inner frame length is larger than the solid-state cathode length by about 20 μm to about 2 mm. In some embodiments, the inner frame length is larger than the solid-state cathode length by about 50 μm to about 2 mm. In some embodiments, the inner frame length is larger than the solid-state cathode length by about 100 μm to about 2 mm. In some embodiments, the inner frame length is larger than the solid-state cathode length by about 200 μm to about 1.5 mm. In some embodiments, the inner frame length is larger than the solid-state cathode length by about 300 μm to about 1.5 mm. In some embodiments, the inner frame length is larger than the solid-state cathode length by about 400 μm to about 1.2 μm.

In some embodiments, the solid-state separator comprises lithium-stuffed garnet. In some embodiments, the solid-state separator consists essentially of lithium-stuffed garnet.

In some embodiments, the solid-state separator is represented by the formula Li_{A}La_{B}Zr_{C}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0<C≤2, 0<D<2; 0<E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}Me″ₑO_{f}, wherein 5<a<7.7; 2<b<4; 0<<<2.5; 0<<<2; 0<<<2, 10<<<13 and Me″ is a metal selected from Nb, V, W, Mo, Ta, Ga, and Sb.

In some embodiments, the solid-state separator has a thickness of about 10 μm to 50 μm.

In a second aspect, the present disclosure provides an electrochemical stack comprising: a) a solid-state cathode having two major surfaces and four minor surfaces, the solid-state cathode comprising a solid catholyte; b) a solid-state separator; c) a cathode current collector; d) a bonding layer; and e) a frame surrounding the four minor surfaces of the solid-state cathode; wherein the frame is positioned between and contacts the cathode current collector and the solid-state separator; wherein the bonding layer is positioned between and contacts the solid-state cathode and the solid-state separator.

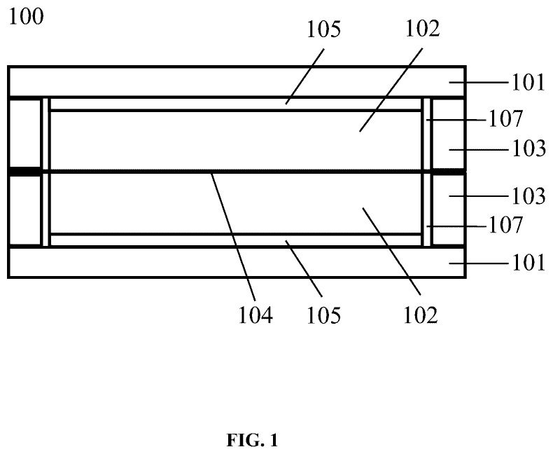

In some embodiments, the electrochemical stack is substantially as shown in FIG. 1. FIG. 1 is not drawn to scale. In FIG. 1, electrochemical stack 100 is illustrated in a cross-sectional view. Electrochemical stack 100 includes a solid-state cathode 102 which is positioned on top of a cathode current collector 104 on both sides of the stack. Electrochemical stack 100 also includes a bonding layer 105, which is positioned on top of the solid-state cathode, a solid-state separator 101, which is positioned on top of a bonding layer 105 and contacts the bonding layer on both sides of the stack. Electrochemical stack 100 also includes a frame 103 which surrounds the four minor surfaces of each solid-state cathode layer and is positioned between a solid-state separator 101 and the cathode current collector 104 on both sides of the stack. Electrochemical stack 100 also includes an empty space 107, in between the minor surfaces of the solid-state cathode and the frame. The solid-state separator 101 may include, in some embodiments, any solid-state separators set forth herein. The solid-state cathode, 102, may include, in some embodiments, any cathode active materials set forth herein. In the solid-state cathode, 102, is a solid catholyte, which may include, in some embodiments, any solid catholyte material set forth herein. The frame, 103, contacts the solid-state separator 101 and the cathode current collector 104. In some non-limiting embodiments, the frame, 103, is attached to the solid-state separator 101 and the cathode current collector 104.

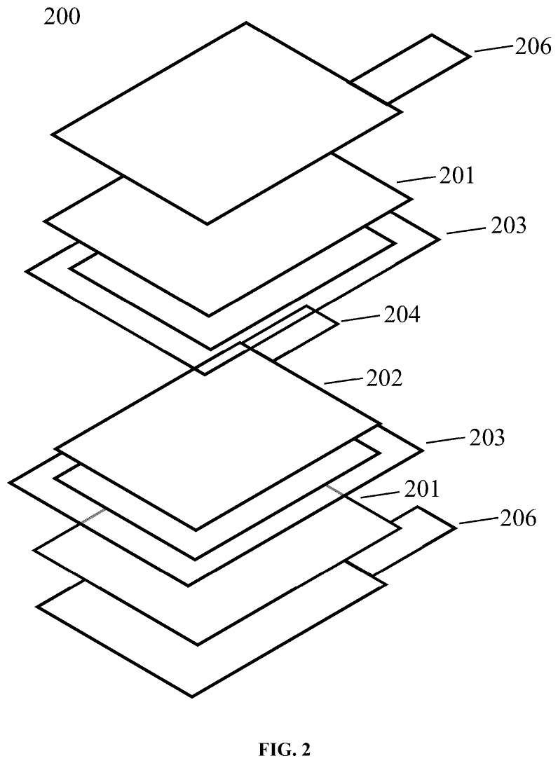

In some embodiments, the electrochemical stack is substantially as shown in FIG. 2. FIG. 2 is not drawn to scale. In FIG. 2, electrochemical stack 200 is illustrated in a vertically stacked view. Electrochemical stack 200 includes a double-sided solid-state cathode 202, that has a bonding layer on both sides, and a cathode current collector 204 disposed in between the double-sided solid-state cathode. Electrochemical stack 200 also includes a solid-state separator 201, which is positioned on top of the double-sided solid-state cathode 202 on both sides of the stack, and contacts the bonding layer on the double-sided solid-state cathode. Electrochemical stack 200 also includes a frame 203, which is positioned in between a solid-state separator 201 and the cathode current collector 204 on both sides of the stack and that is ultimately on the same plane as and surrounds each layer of the double-sided solid-state cathode 202. Electrochemical stack 200 also includes an anode current collector 206, which is positioned on top of a solid-state separator 201 on both sides of the stack. The solid-state separator 201 may include, in some embodiments, any solid-state separator set forth herein. The solid-state cathode, 202, may include, in some embodiments, any cathode active materials set forth herein. In the solid-state cathode, 202, is a solid catholyte, which may include, in some embodiments, any solid catholyte materials set forth herein. When fully assembled, the frame, 203, contacts the solid-state separator 201 and the cathode current collector 204. In some non-limiting embodiments, the frame, 203, is attached to the solid-state separator 201 and the cathode current collector 204.

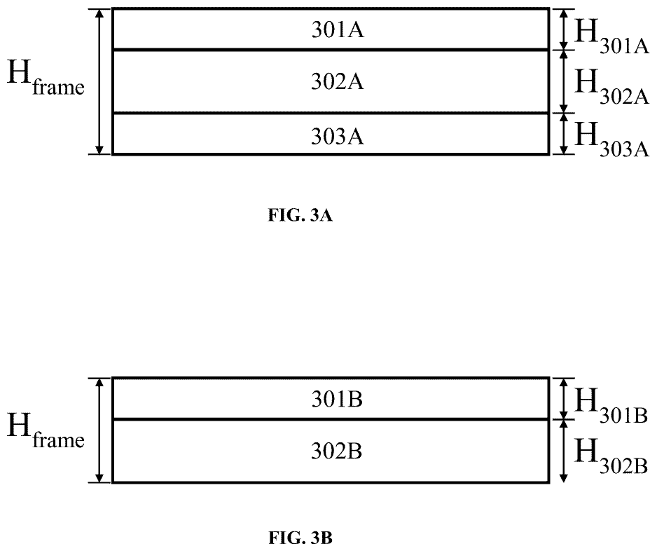

FIG. 3A is not drawn to scale. FIG. 3A is a cross-sectional image of a frame comprising multiple layers 301A-303A. In some embodiments, the frame comprises one or more layers. In some embodiments, the frame comprises two or more layers. In some embodiments, the frame comprises three or more layers. The cross-sectional thickness of the frame is shown as H_{frame}. The cross-sectional thickness of the first layer, 301A, of the frame is shown as H_{301A}. The cross-sectional thickness of the second layer, 302A, of the frame is shown as H_{302A}. The cross-sectional thickness of the second layer, 303A, of the frame is shown as H_{303A}. The sum of the cross-sectional thickness of each layer, H_{301A}, H_{302A}, and H_{303A} is equal to the cross-sectional thickness of the frame, H_{frame}. In some non-limiting embodiments, the cross-sectional thickness of the first layer, H_{301A}, is the same as the cross-sectional thickness of the third layer, H_{303A}. In some non-limiting embodiments, the cross-sectional thickness of the first layer, H_{301A}, is different from the cross-sectional thickness of the third layer, H_{303A}. In some non-limiting embodiments, the cross-sectional thickness of the second layer, H_{302A}, is larger than the cross-sectional thickness of the first layer, H_{301A}, and, separately, the cross-sectional thickness of the third layer, H_{303A}.

FIG. 3B is not drawn to scale. FIG. 3B is a cross-sectional image of a frame comprising multiple layers 301B-302B. In some embodiments, the frame comprises one or more layers. In some embodiments, the frame comprises two or more layers. The cross-sectional thickness of the frame is shown as H_{frame}. The cross-sectional thickness of the first layer, 301B, of the frame is shown as H_{301B}. The cross-sectional thickness of the second layer, 302B, of the frame is shown as H_{302B}. The sum of the cross-sectional thickness of each layer, H_{301B} and H_{302B} is equal to the cross-sectional thickness of the frame, H_{frame}. In some non-limiting embodiments, the cross-sectional thickness of the first layer, H_{301B}, is different from the cross-sectional thickness of the second layer, H_{302B}. In some non-limiting embodiments, the cross-sectional thickness of the second layer, H_{302B}, is larger than the cross-sectional thickness of the first layer, H_{301B}.

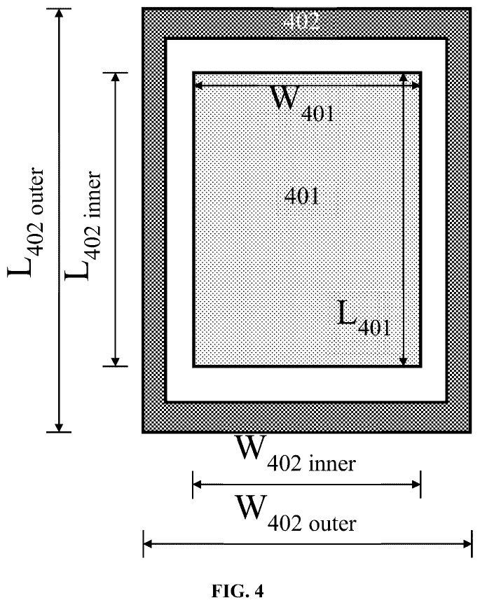

FIG. 4 is not drawn to scale. FIG. 4 is a top-down image of a frame 402 surrounding a solid-state cathode 401. The outer width and length of the frame 402 is shown as W_{402 outer} and L_{402 outer}, respectively. The inner width and length of the frame 402 is shown as W_{402 inner} and L_{402 inner}, respectively. The width and length of the solid-state cathode 401 is shown as W₄₀₁ and L₄₀₁, respectively. In some embodiments, the inner width of the frame, W₄₀₂ inner, is larger than the width of the solid-state cathode, W₄₀₁. In some embodiments, the inner length of the frame, L_{402 inner}, is larger than the length of the solid-state cathode, L₄₀₁.

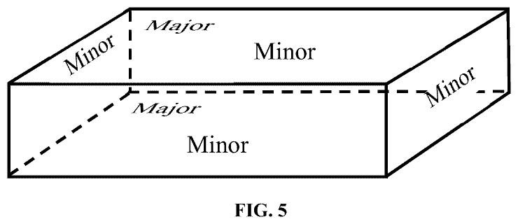

FIG. 5 is not drawn to scale. FIG. 5 is a three-dimensional image of a solid-state cathode with minor surfaces and major surfaces. The major surfaces are labelled as the two surfaces along the top and bottom of the solid-state cathode. The minor surfaces are labelled as the four surfaces along the four sides of the solid-state cathode. The major surfaces individually have higher surface areas than each of the four side surfaces.

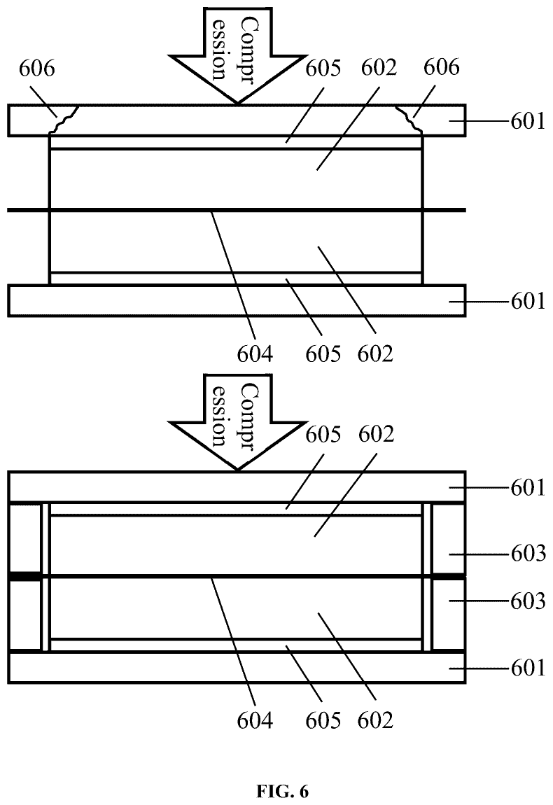

FIG. 6 is not drawn to scale. FIG. 6 is an image demonstrating the effects of compressing an electrochemical stack with and without a frame. The top electrochemical stacks includes a solid-state separator 601, which is positioned on top of a bonding layer 605, which is positioned on top of a solid-state cathode 602, which is positioned on top of a cathode current collector 604. The bottom electrochemical stack includes a solid-state separator 601, which is positioned on top of a bonding layer 605, which is positioned on top of a solid-state cathode 602, which is positioned on top of a cathode current collector 604, and additionally, a frame 603, which is positioned between the solid-state separator 601 and the cathode current collector 604. In a cell stack with no frame, compression or application of pressure to the cell stack, such as during assembly, leads to cracks 606 in the solid-state separator 601 in the top electrochemical. In a cell stack with a frame 603, compression or application of pressure to the cell stack does not lead to major cracks or defects in any electrochemical stack component in the bottom electrochemical stack with frame 603. The use of the frame in a cell stack is important to reduce the formation of cracks in the solid-state separator during and after formation of the cell stack.

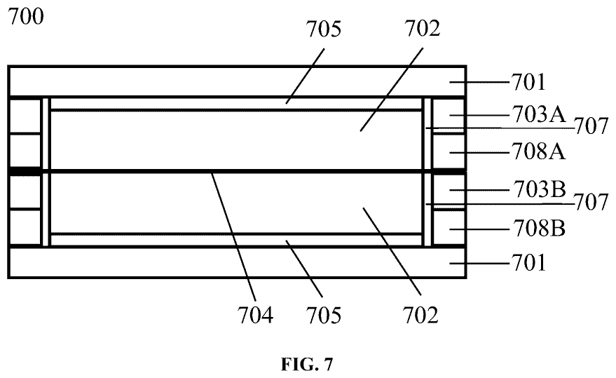

In some embodiments, the electrochemical stack is substantially as shown in FIG. 7. FIG. 7 is not drawn to scale. In FIG. 7, electrochemical stack 700 is illustrated in a cross-sectional view. Electrochemical stack 700 includes a solid-state cathode 702 which is positioned on top of a cathode current collector 704 on both sides of the stack. Electrochemical stack 700 also includes a bonding layer 705, which is positioned on top of the solid-state cathode, a solid-state separator 701, which is positioned on top of a bonding layer 705 and contacts the bonding layer on both sides of the stack. Electrochemical stack 700 also includes two frames, each surrounding the four minor surfaces of each solid-state cathode layer and positioned between a solid-state separator 701 and the cathode current collector 704 on both sides of the stack. The frames comprise two layers each (703A/708A or 703B/708B), wherein each layer comprises a thermoplastic polymer. In some embodiments, layers 708A and 703B comprise the same thermoplastic polymer. In some embodiments, layers 703A and 708B comprise the same thermoplastic polymer, and in other embodiments, layers 703A and 708B do not comprise the same thermoplastic polymer. Electrochemical stack 700 also includes an empty space 707, in between the minor surfaces of the solid-state cathode and each frame. The solid-state separator 701 may include, in some embodiments, any solid-state separators set forth herein. The solid-state cathode, 702, may include, in some embodiments, any cathode active materials set forth herein. In the solid-state cathode, 702, is a solid catholyte, which may include, in some embodiments, any solid catholyte material set forth herein. The frames, on each side of the stack, contact the solid-state separator 701 and the cathode current collector 704. In some non-limiting embodiments, the frames, on each side of the stack, are attached to the solid-state separator 701 and the cathode current collector 704. In other non-limiting embodiments, the frames, on each side of the stack, contact the solid-state separator 701 and are attached to the cathode current collector 704.

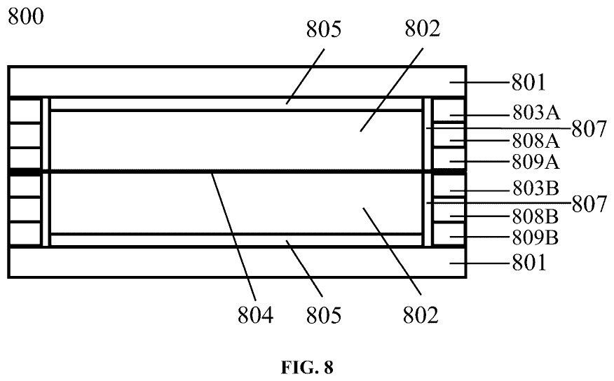

In some embodiments, the electrochemical stack is substantially as shown in FIG. 8. FIG. 8 is not drawn to scale. In FIG. 8, electrochemical stack 800 is illustrated in a cross-sectional view. Electrochemical stack 800 includes a solid-state cathode 802 which is positioned on top of a cathode current collector 804 on both sides of the stack. Electrochemical stack 800 also includes a bonding layer 805, which is positioned on top of the solid-state cathode, a solid-state separator 801, which is positioned on top of a bonding layer 805 and contacts the bonding layer on both sides of the stack. Electrochemical stack 800 also includes two frames, each surrounding the four minor surfaces of each solid-state cathode layer and positioned between a solid-state separator 801 and the cathode current collector 804 on both sides of the stack. The frames comprise three layers each (803A/808A/809A or 803B/808B/809B), wherein each layer comprises a thermoplastic polymer. In some embodiments, layers 803A and 809A, layers 803B and 809B, or layers 803A, 809A, 803B, and 809B may comprise the same thermoplastic polymer. In other embodiments, layer 808A comprises a different thermoplastic polymer than that of layer 803A and of layer 809A. In further embodiments, layer 808B comprises a different thermoplastic polymer than that of layer 803B and of layer 809B. In some embodiments, layer 808A and layer 808B comprise the same thermoplastic polymer, and in other embodiments, layer 808A and layer 808B do not comprise the same thermoplastic polymer. Electrochemical stack 800 also includes an empty space 807, in between the minor surfaces of the solid-state cathode and each frame. The solid-state separator 801 may include, in some embodiments, any solid-state separators set forth herein. The solid-state cathode, 802, may include, in some embodiments, any cathode active materials set forth herein. In the solid-state cathode, 802, is a solid catholyte, which may include, in some embodiments, any solid catholyte material set forth herein. The frames, on each side of the stack, contact the solid-state separator 801 and the cathode current collector 804. In some non-limiting embodiments, the frames, on each side of the stack, are attached to the solid-state separator 801 and the cathode current collector 804. In other non-limiting embodiments, the frames, on each side of the stack, contact the solid-state separator 801 and are attached to the cathode current collector 804.

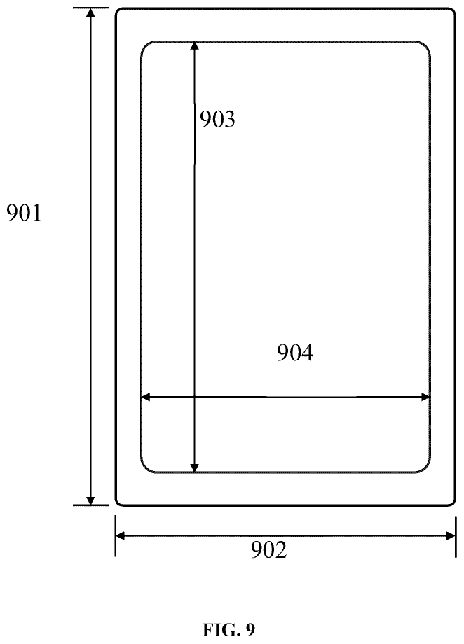

FIG. 9 is not drawn to scale. FIG. 9 is a top-down image of a frame 900. The outer width and length of the frame 900 is shown as 902 and 901, respectively. The inner width and length of the frame 900 is shown as 904 and 903, respectively.

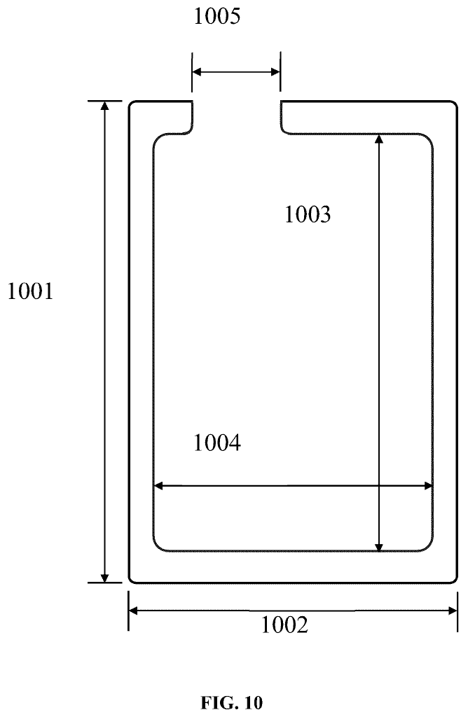

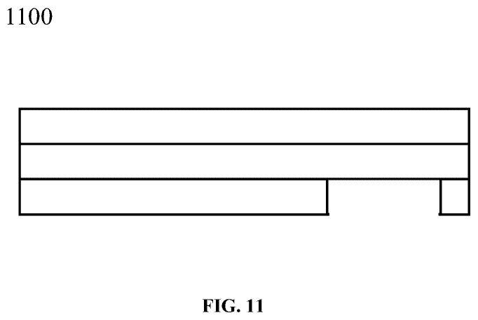

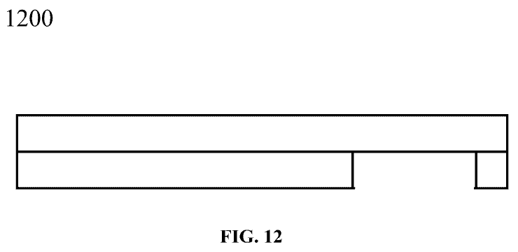

FIG. 10 is not drawn to scale. FIG. 10 is a top-down image of a frame 1000 with an opening. The outer width and length of the frame 1000 is shown as 1002 and 1001, respectively. The inner width and length of the frame 1000 is shown as 1004 and 1003, respectively. The length of the opening of the frame 1000 is shown as 1005. In some embodiments, the length of the opening is sufficient to place a tab.

### III. Methods of Assembling an Electrochemical Stack

In a third aspect, the present disclosure provides a method of assembling an electrochemical stack comprising:
(1) providing an electrochemical stack; wherein the electrochemical stack comprises: a frame as described herein; a solid-state cathode, a bonding layer, and a solid-state separator; and
(2) applying a pressure of about 70 kPa to about 700 kPa the electrochemical stack.

In some embodiments, the pressure applied in (2) is about 70 kPa to about 620 kPa. In some embodiments, the pressure applied in (2) is about 130 kPa to about 620 kPa. In some embodiments, the pressure applied in (2) is about 130 kPa to about 550 kPa. In some embodiments, the pressure applied in (2) is about 200 kPa to about 550 kPa. In some embodiments, the pressure applied in (2) is about 200 kPa to about 480 kPa. In some embodiments, the pressure applied in (2) is about 270 kPa to about 480 kPa. In some embodiments, the pressure applied in (2) is about 270 kPa to about 420 kPa.

In some embodiments, (2) is performed at a temperature of about 80° C. to about 160° C. In some embodiments, (2) is performed at a temperature of about 90° C. to about 160° C. In some embodiments, (2) is performed at a temperature of about 100° C. to about 160° C. In some embodiments, (2) is performed at a temperature of about 110° C. to about 160° C. In some embodiments, (2) is performed at a temperature of about 120° C. to about 160° C. In some embodiments, (2) is performed at a temperature of about 130° C. to about 160° C. In some embodiments, (2) is performed at a temperature of about 140° C. to about 160° C.

In some embodiments, (2) is performed at a temperature of about 65° C. to about 75° C., followed by a temperature of 80° C. to about 160° C. In some embodiments, (2) is performed at a temperature of about 65° C. to about 75° C., followed by a temperature of 90° C. to about 160° C. In some embodiments, (2) is performed at a temperature of about 65° C. to about 75° C., followed by a temperature of 100° C. to about 160° C. In some embodiments, (2) is performed at a temperature of about 65° C. to about 75° C., followed by a temperature of 110° C. to about 160° C. In some embodiments, (2) is performed at a temperature of about 65° C. to about 75° C., followed by a temperature of 120° C. to about 160° C. In some embodiments, (2) is performed at a temperature of about 65° C. to about 75° C., followed by a temperature of 130° C. to about 160° C. In some embodiments, (2) is performed at a temperature of about 65° C. to about 75° C., followed by a temperature of 140° C. to about 160° C.

In some embodiments the pressure applied in (2) is about 70 kPa to about 700 kPa and (2) is performed at a temperature of about 80° C. to about 160° C. In some embodiments, the pressure applied in (2) is about 70 kPa to about 700 kPa and (2) is performed at a temperature of about 65° C. to about 75° C., followed by a temperature of 80° C. to about 160° C.

In some embodiments, (2) is performed for about 20 minutes, about 15 minutes, about 10 minutes, or about 5 minutes.

In some embodiments, (2) is performed for less than about 20 minutes, less than about 15 minutes, less than about 10 minutes, or less than about 5 minutes.

In some embodiments, (2) is performed for about 5 minutes to about 20 minutes. In some embodiments, (2) is performed for about 10 minutes to about 20 minutes. In some embodiments, (2) is performed for about 15 minutes to about 20 minutes.

In some embodiments, the electrochemical stack further comprises an additional solid-state cathode, an additional solid-state separator, an additional bonding layer, and an additional frame.

In some embodiments, the frame is attached to the solid-state separator and the cathode current collector. In other embodiments, the frame is attached to the solid-state separator and contacts the cathode current collector. In other embodiments, the frame contacts the solid-state separator and is attached to the current collector.

In some embodiments, the method of assembling an electrochemical stack may be performed with an electrode stacking device. In some embodiments, the method of assembling an electrochemical stack may be performed manually.

### NON-LIMITING EMBODIMENTS

The present disclosure provides at least the following non-limiting embodiments:
(a) An electrochemical stack comprising:
   a solid-state cathode having two major surfaces, four minor surfaces, a first width and a first length, the solid-state cathode comprising a solid catholyte;
   a solid-state separator having a second width and a second length;
   a cathode current collector;
   a bonding layer; and
   a frame;
   wherein the frame surrounds the four minor surfaces of the solid-state cathode;
   wherein the frame is positioned between and contacts the cathode current collector and the solid-state separator;
   wherein the bonding layer is positioned between and contacts the solid-state cathode and the solid-state separator; and
   wherein the first width is smaller than the second width; and the first length is smaller than the second length.
(b) The electrochemical stack of (a), wherein the frame is attached to the solid-state separator and the cathode current collector.
(c) The electrochemical stack of (a), wherein the frame is attached to the cathode current collector.
(d) The electrochemical stack of any one of embodiments (a)-(c), wherein the frame comprises a thermoplastic polymer.
(e) The electrochemical stack of (d), wherein the thermoplastic polymer is selected from a polyethylene polymer, a polypropylene polymer, a polybutylene polymer, a polypentene polymer, a polystyrene polymer, a polyaryletherketone polymer, a polyaryletherimide polymer, a polysulfone polymer, an acrylate polymer, a polycarbonate polymer, or combinations thereof.
(f) The electrochemical stack of any one of embodiments (d)-(e), wherein the thermoplastic polymer is selected from a modified polyethylene polymer, a modified polypropylene polymer, a modified polybutylene polymer, a modified polypentene polymer, a modified polystyrene polymer, a modified polyaryletherketone polymer, a modified polyaryletherimide polymer, a modified polysulfone polymer, a modified acrylate polymer, a modified perfluoroelastomer polymer, a modified polycarbonate polymer, or combinations thereof.
(g) The electrochemical stack of any one of embodiments (d)-(f), wherein the thermoplastic polymer is selected from acrylonitrile butadiene styrene (ABS), ethylene-propylene rubber (EPM), ethylene propylene diene rubber (EPDM), fluorinated ethylene propylene (FEP), perfluoroelastomer (FFKM), polybutene-1 (PB-1), polycarbonate (PC), polyether ether ketone (PEEK), polyetherimide (PEI), polyether sulfone (PES), polyethylene terephthalate (PET), polyisobutylene (PIB), polyisoprene, poly(methyl methacrylate) (PMMA), polymethylpentene (PMP), polytetrafluoroethylene (PTFE), polyvinylidene difluoride (PVDF), polyvinylidene difluoride-co-fluoro ethylene propylene (PVDF-co-FEP), poly(styrene-isoprene-styrene) (SIS), poly(styrene-butadiene-styrene) (SBS), ultra-high molecular-weight polyethylene (UHWPE), or combinations thereof.
(h) The electrochemical stack of any one of embodiments (f)-(g), wherein the modified polyethylene polymer is a maleic anhydride polyethylene copolymer.
(i) The electrochemical stack of (h) wherein the maleic anhydride polyethylene copolymer is cross-linked.
(j) The electrochemical stack of any one of embodiments (a)-(i), wherein the frame comprises one or more layers.
(k) The electrochemical stack of any one of embodiments (a)-(j), wherein the frame comprises two or more layers.
(l) The electrochemical stack of any one of embodiments (a)-(k), wherein the frame comprises three or more layers.
(m) The electrochemical stack of any one of embodiments (j)-(l), wherein each layer comprises a thermoplastic polymer.
(n) The electrochemical stack of any one of embodiments (a)-(m), wherein the frame comprises a first layer and a second layer, and wherein the first layer of the frame and the second layer of the frame comprise the same thermoplastic polymer.
(o) The electrochemical stack of any one of embodiments (a)-(m), wherein the frame comprises a first layer and a second layer, and wherein the first layer of the frame and the second layer of the frame comprise different thermoplastic polymers.
(p) The electrochemical stack of (o), wherein the first layer of the frame comprises a cross-linked, maleic anhydride polyethylene copolymer.
(q) The electrochemical stack of any one of embodiments (a)-(m), wherein the frame comprises a first layer, a second layer, and a third layer, and wherein the first layer of the frame and the third layer of the frame comprise the same thermoplastic polymer.
(r) The electrochemical stack of any one of embodiments (a)-(m), wherein the frame comprises a first layer, a second layer, and a third layer wherein the first layer of the frame and third layer of the frame comprise different thermoplastic polymers.
(s) The electrochemical stack of any one of embodiments (q)-(s), wherein the second layer of the frame comprises a different thermoplastic polymer than the first layer and the third layer.
(t) The electrochemical stack of any one of embodiments (q) or(s), wherein the first layer of the frame and third layer comprise a cross-linked, maleic anhydride polyethylene copolymer.
(u) The electrochemical stack of any one of embodiments (n)-(t), wherein the second layer of the frame comprises PEEK.
(v) The electrochemical stack of any one of embodiments (n)-(t), wherein the second layer of the frame comprises PTFE.
(w) The electrochemical stack of any one of embodiments (n)-(t), wherein the second layer of the frame comprises a polyimide polymer.
(x) The electrochemical stack of any one of embodiments (n)-(t), wherein the second layer of the frame comprises a porous polyimide polymer.
(y) The electrochemical stack of any one of embodiments (a)-(x), wherein the thermoplastic polymer comprises initial dimensions prior to heating or pressure application or heating and pressure application and final dimensions after heating or pressure application or heating and pressure application, and wherein the thermoplastic polymer does not shrink or expand by more than about 5% with respect to the initial dimensions after heating to a temperature of about 80° C. to about 160° C.
(z) The electrochemical stack of any of embodiments (a)-(y), wherein the thermoplastic polymer does not shrink or expand by more than about 5% with respect to the initial dimensions after pressure application.
(aa) The electrochemical stack of any of embodiments (a)-(z), wherein the thermoplastic polymer does not shrink or expand by more than about 5% with respect to the initial dimensions after heating to a temperature of about 80° C. to about 160° C. and pressure application.
(bb) The electrochemical stack of any one of embodiments (a)-(aa), wherein the thermoplastic polymer has a Poisson's ratio of about 0.2 to about 0.3 at a temperature of about 110° C. to about 150° C. and an applied pressure of about 250 kPa to about 700 kPa.
(cc) The electrochemical stack of any one of embodiments (a)-(bb), wherein the each of the one or more individual layers of the frame has a thickness, wherein the sum of the thicknesses of all layers is a total thickness of the frame, and wherein the total thickness of the frame is about 80 μm to about 200 μm.
(dd) The electrochemical stack of any one of embodiments (n)-(p), wherein the first layer has a thickness of about 10 μm to about 60 μm.
(ee) The electrochemical stack of any one of embodiments (n)-(p), wherein the thickness of the second layer is about 50% to about 90% of the total thickness of the frame.
(ff) The electrochemical stack of any one of embodiments (n)-(p), wherein the thickness of the second layer is about 20 μm to about 140 μm.
(gg) The electrochemical stack of any one of embodiments (q)-(t), wherein the first layer and the third layer have a different thickness.
(hh) The electrochemical stack of (gg), wherein the first layer has a thickness of about 10 μm to about 50 μm.
(ii) The electrochemical stack of (gg), wherein the third layer has a thickness of about 20 μm to about 60 μm.
(jj) The electrochemical stack of any one of embodiments (q)-(t), wherein the first layer and third layer have the same thickness.
(kk) The electrochemical stack of (jj), wherein the first layer and third layer each have a thickness of about 10 μm to about 60 μm.
(ll) The electrochemical stack of any one of embodiments (q)-(t), wherein the thickness of the second layer is about 30% to about 70% of the total thickness of the frame.
(mm) The electrochemical stack of any one of embodiments (q)-(t), wherein the thickness of the second layer is about 20 μm to about 140 μm.
(nn) The electrochemical stack of any one of embodiments (a)-(mm), wherein the frame comprises an inner frame length and an outer frame length, wherein the inner frame length is about 60 mm to about 85 mm.
(oo) The electrochemical stack of (nn), wherein the outer frame length is about 70 mm to about 95 mm.
(pp) The electrochemical stack of any one of embodiments (a)-(oo), wherein the frame comprises an inner frame width and an outer frame width, wherein the inner frame width is about 45 mm to about 70 mm.
(qq) The electrochemical stack of (pp), wherein the outer frame width is about 55 mm to 80 mm.
(rr) The electrochemical stack of any one of embodiments (a)-(qq), wherein the difference between the outer frame length and the inner frame length is about 5 mm to about 35 mm.
(ss) The electrochemical stack of any one of embodiments (a)-(qq), wherein the difference between the outer frame width and the inner frame width is about 5 mm to about 35 mm.
(tt) The electrochemical stack of any one of embodiments (a)-(ss), wherein the inner frame width and inner frame length are respectively larger than the solid-state cathode width and length by at least about 20 μm.
(uu) The electrochemical stack of any one of embodiments (a)-(tt), wherein the solid-state separator comprises lithium-stuffed garnet.
(vv) The electrochemical stack of any one of embodiments (a)-(uu), wherein the solid-state separator consists essentially of lithium-stuffed garnet.
(ww) The electrochemical stack of any one of embodiments (a)-(vv), wherein the lithium-stuffed garnet separator is represented by the formula Li_{A}La_{B}Zr_{C}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0<C≤2, 0<D<2; 0<E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}Me″ₑO_{f}, wherein 5<a<7.7; 2<b<4; 0<c≤2.5; 0<d<2; 0<e<2, 10<f<13 and Me″ is a metal selected from Nb, V, W, Mo, Ta, Ga, and Sb.
(xx) The electrochemical stack of any one of embodiments (a)-(ww), further comprising a second solid-state cathode, a second solid-state separator, a second bonding layer, and a second frame.
(yy) An electrochemical stack comprising:
   a solid-state cathode having two major surfaces and four minor surfaces, the solid-state cathode comprising a solid catholyte;
   a solid-state separator;
   a cathode current collector;
   a bonding layer; and
   a frame surrounding the four minor surfaces of the solid-state cathode;
   wherein the frame is positioned between and contacts the cathode current collector and the solid-state separator;
   wherein the bonding layer is positioned between and contacts the solid-state cathode and the solid-state separator.
(zz) A method of assembling an electrochemical stack comprising:
   i. providing an electrochemical stack, wherein the electrochemical stack comprises: a frame as in any of the electrochemical stacks of embodiments (a)-(ww); a solid-state cathode, a bonding layer, and a solid-state separator; and
   ii. applying a pressure of about 70 kPa to about 700 kPa to the electrochemical stack.
(aaa) The method of (zz), wherein (ii) is performed at a temperature of about 80° C. to about 160° C.
(bbb) The method of any one of embodiments (zz)-(aaa), wherein the electrochemical stack comprises a second solid-state cathode, a second solid-state separator, a second bonding layer, and a second frame.
(ccc) The method of any one of embodiments (zz)-(bbb), wherein the frame attaches to the solid-state separator and the cathode current collector.
(ddd) The method of any one of embodiments (zz)-(bbb), wherein the frame attaches to the cathode current collector and contacts the solid-state separator.
(eee) The method of any one of embodiments (zz)-(ddd), wherein the frame comprises a thermoplastic polymer.
(fff) The method of any one of embodiments (zz)-(eee), wherein the frame comprises one or more layers.
(ggg) The method of any one of embodiments (zz)-(fff), wherein the solid-state separator comprises lithium-stuffed garnet.
(hhh) A method of assembling an electrochemical stack comprising:
   i. providing a frame as in any of the electrochemical stacks of embodiments (a)-(ww);
   ii. providing a solid-state cathode with a bonding layer on one major surface of the solid-state cathode;
   iii. placing the solid-state cathode within the frame, wherein the frame surrounds all four minor surfaces of the solid-state cathode, thus forming a sub-stack;
   iv. applying a pressure of about 70 kPa to about 700 kPa at a temperature of about 65° C. to about 75° C. to the sub-stack;
   v. placing a solid-state separator on top of the bonding layer, thus forming an electrochemical stack; and
   vi. applying a pressure of about 70 kPa to about 700 kPa at a temperature of about 80° C. to about 160° C. to the electrochemical stack.
(iii) A method of assembling an electrochemical stack comprising:
   i. providing a frame as in any of embodiments (a)-(ww);
   ii. placing a solid-state cathode within the frame, wherein the frame surrounds all four minor surfaces of the solid-state cathode, thus forming a sub-stack;
   iii. applying a pressure of about 70 kPa to about 700 kPa at a temperature of about 65° C. to about 75° C. to the sub-stack;
   iv. providing a solid-state separator with a bonding layer;
   v. placing the solid-state cathode with frame on top of the bonding layer, thus forming an electrochemical stack; and
   vi. applying a pressure of about 70 kPa to about 700 kPa at a temperature of about 80° C. to about 160° C. to the electrochemical stack.
(jjj) A method of assembling an electrochemical stack comprising:
   i. providing a frame as in any of embodiments (a)-(ww);
   ii. placing the frame on top of a solid-state separator, thus forming a sub-stack;
   iii. applying a pressure of about 70 kPa to about 700 kPa at a temperature of about 65° C. to about 75° C. to the sub-stack;
   iv. providing a solid-state cathode with a bonding layer on one major surface of the solid-state cathode;
   v. placing the solid-state cathode with bonding layer on top of the solid-state separator with frame, wherein the frame surrounds the four minor surfaces of the solid-state-cathode and wherein the bonding layer contacts the solid-state separator, thus forming an electrochemical stack; and
   vi. applying a pressure of about 70 kPa to about 700 kPa at a temperature of about 80° C. to about 160° C. to the electrochemical stack.
(kkk) A method of assembling an electrochemical stack comprising:
   i. providing a frame as in any of embodiments (a)-(ww);
   ii. providing a solid-state separator with a bonding layer;
   iii. placing the frame on top of the solid-state separator, thus forming a sub-stack;
   iv. applying a pressure of about 70 kPa to about 700 kPa at a temperature of about 65° C. to about 75° C. to the sub-stack;
   v. placing a solid-state cathode on top of the solid-state separator with frame, wherein the frame surrounds the four minor surfaces of the solid-state-cathode and wherein the bonding layer contacts the solid-state cathode, thus forming an electrochemical stack; and
   vi. applying a pressure of about 70 kPa to about 700 kPa at a temperature of about 80° C. to about 160° C. to the electrochemical stack.
(lll) A method of assembling an electrochemical stack comprising:
   i. providing a frame as in any of embodiments (a)-(ww);
   ii. providing a solid-state cathode with a bonding layer on one major surface of the solid-state cathode;
   iii. placing the solid-state cathode within the frame, wherein the frame surrounds the four minor surfaces of the solid-state cathode and placing a solid-state separator on top of the bonding layer, thus forming an electrochemical stack;
   iv. applying a pressure of about 70 kPa to about 700 kPa at a temperature of about 65° C. to about 75° C. to the electrochemical stack; and
   v. applying a pressure of about 70 kPa to about 700 kPa at a temperature of about 80° C. to about 160° C. to the electrochemical stack.
(mmm) A method of assembling an electrochemical stack comprising:
   i. providing a frame as in any of embodiments (a)-(ww);
   ii. providing a solid-state separator with a bonding layer;
   iii. placing a solid-state cathode within the frame, wherein the frame surrounds the four minor surfaces of the solid-state cathode and placing the solid-state separator with bonding layer on top of the solid-state cathode with frame, wherein the bonding layer contacts the solid-state cathode, thus forming an electrochemical stack;
   iv. applying a pressure of about 70 kPa to about 700 kPa at a temperature of about 65° C. to about 75° C. to the electrochemical stack;
v. applying a pressure of about 70 kPa to about 700 kPa at a temperature of about 80° C. to about 160° C. to the electrochemical stack.

### EXAMPLES

Reagents, chemicals, and materials disclosed herein were commercially purchased unless stated otherwise.

Unless specified otherwise, lithium-stuffed garnet films were prepared as follows. A slurry of lithium-stuffed garnet precursor materials were deposited by the doctor-blade method on aluminum-based setters and sintered at 1000° C. to 1300° C. to prepare thin films of lithium-stuffed garnet that were about 20 microns to 50 microns (μm) in thickness.

Unless specified otherwise, bilayer (film on metal foil) were prepared as follows. A slurry of lithium-stuffed garnet precursor materials was cast onto a metal foil and dried to form a green tape. The bilayer was sintered at 1000° C. to 1300° C. The sintered films were then cut to the appropriate dimensions using a laser cutter. The bilayer films herein are prepared, for example, as in WO/2022/192464, published Sep. 15, 2022, the entire contents of which is incorporated by reference.

Unless specified otherwise, lithium-stuffed garnet films and bilayer films used in electrochemical assembly had larger outer dimensions of both major surfaces (i.e., length and width of the major surfaces) than the respective outer dimensions of the double-sided solid-state cathodes used in each respective cell.

### Example 1—Method 1: Electrochemical Stack Assembly Process Comprising a Solid Cathode Frame

A PTFE liner was placed on a stainless-steel substrate to prevent static and attachment of any electrochemical stack components during assembly. Next, a first frame was placed on the PTFE liner. The frame had three layers, each layer having a thermoplastic polymer. Separately, a lithium borohydride bonding layer was deposited on both layers of a double-sided solid-state cathode with a cathode current collector disposed in between the two solid-state cathode layers. The double-sided solid-state cathode was placed within the frame and centered with respect to the frame center and one cathode layer of the double-sided cathode. Next, a second frame identical to the first frame was placed and centered with respect to the frame center and the second cathode layer of the double-sided cathode. The inner frame length, inner frame width, and overall frame thickness were larger than the respective length, width, and thickness of either of the solid-state cathode layers of the double-sided solid-state cathode. A second PTFE liner followed by a second stainless steel substrate was placed on top of the assembly. A high-temperature silicone foam was added on the top stainless-steel plate to provide uniform pressure distribution.

The assembly was heated at a temperature of about 65° C. to about 75° C. and at a pressure of about 70 kPa to about 700 kPa for 2 minutes. The assembly was taken out and allowed to cool to room temperature. Separately, an anode current collector was applied to a lithium-stuffed garnet solid-state separator. The lithium-stuffed garnet solid-state separator was placed on top of the frame on both sides of the assembly to form a stack. Finally, the stack was heated at a temperature of about 80° C. to about 160° C. and at a pressure of about 70 kPa to about 700 kPa for a few minutes.

### Example 2—Method 2: Electrochemical Cell Assembly Process Comprising a Solid Cathode Frame

A lithium borohydride bonding layer was deposited on both layers of a double-sided solid-state cathode with a cathode current collector disposed in between the two solid-state cathode layers. An anode current collector was applied to one side of a lithium-stuffed garnet solid-state separator.

An electrochemical stack was assembled using an electrode stacking device. A frame was automatically stacked on top of a lithium-stuffed garnet solid-state separator, on the side opposite of the anode current collector, and aligned with respect to the frame center. The frame had three layers, each layer having a thermoplastic polymer. The assembly was heated at a temperature of about 65° C. to about 75° C. and at a pressure of about 70 kPa to about 700 kPa for 2 minutes. The assembly was then taken out and allowed to cool to room temperature. The double-sided solid-state cathode with bonding layer was placed within the frame and centered with respect to the frame center and one cathode layer of the double-sided cathode. Next, a second frame identical to the first frame was placed and centered with respect to the frame center and the second cathode layer of the double-sided cathode. The double-sided solid-state cathode was automatically aligned with respect to the frame center of each frame so that the frames surrounded each cathode layer of the double-sided solid-state cathode. The inner frame length, inner frame width, and overall frame thickness for both frames were larger than the respective length, width, and thickness of either of the solid-state cathode layers of the double-sided solid-state cathode. Then, another lithium-stuffed garnet solid-state separator was placed on the top of the top frame, contacting with both top bonding layer and frame.

Finally, the stack was heated at a temperature of about 80° C. to about 160° C. and at a pressure of about 70 kPa to about 700 kPa for a few minutes.

### Example 3—Method 3: Electrochemical Cell Assembly Process Comprising a Solid Cathode Frame

A PTFE liner was placed on a stainless-steel substrate to prevent static and attachment of any electrochemical stack components during assembly. Next, a first frame was placed on the PTFE liner. The frame had two layers, each layer had a thermoplastic polymer. One of the thermoplastic polymers was a cross-linked, maleic anhydride polyethylene copolymer. A double-sided solid-state cathode, with a cathode current collector disposed in between the two solid-state cathode layers, was placed within the frame and centered with respect to the frame center and one cathode layer of the double-sided cathode. The cross-linked, maleic anhydride polyethylene copolymer layer of the frame faced towards the cathode current collector. Next, a second frame identical to the first frame was placed and centered with respect to the frame center and the second cathode layer of the double-sided cathode, with the cross-linked, maleic anhydride polyethylene copolymer layer of the frame facing towards the cathode current collector. The inner frame length, inner frame width, and overall frame thickness were larger than the respective length, width, and thickness of either of the solid-state cathode layers of the double-sided solid-state cathode. A second PTFE liner followed by a second stainless steel substrate was placed on top of the assembly. A high-temperature silicone foam was added on the top stainless-steel plate to provide uniform pressure distribution.

The assembly was heated at a temperature of about 65° C. to about 75° C. and at a pressure of about 70 kPa to about 700 kPa for 2 minutes. The assembly was taken out and allowed to cool to room temperature.

Next, a lithium borohydride bonding layer was deposited on both layers of the double-sided cathode.

Separately, an anode current collector was applied to a lithium-stuffed garnet solid-state separator. The lithium-stuffed garnet solid-state separator was placed on top of the frame on both sides of the assembly to form a stack.

Finally, the stack was heated at a temperature of about 80° C. to about 160° C. and at a pressure of about 70 kPa to about 700 kPa for a few minutes.

### Example 4—Method 4: Electrochemical Cell Assembly Process Comprising a Solid Cathode Frame

A lithium borohydride bonding layer was deposited on one side of a lithium-stuffed garnet solid-state separator. Next, an anode current collector was applied to the other side of the separator to form a lithium-stuffed garnet solid-state separator assembly.

An electrochemical stack was assembled using an electrode stacking device. A double-sided solid-state cathode with a cathode current collector disposed in between the two solid-state cathode layers was automatically stacked on top of a frame and aligned with respect to the frame center and one cathode layer of the double-sided cathode. The frame had two layers, each layer had a thermoplastic polymer. One of the thermoplastic polymers was a cross-linked, maleic anhydride polyethylene copolymer, which faced towards the cathode current collector. Next, a second frame identical to the first frame was placed and centered with respect to the frame center and the second cathode layer of the double-sided cathode. The cross-linked, maleic anhydride polyethylene copolymer layer of the second frame faced towards the cathode current collector. The inner frame length, inner frame width, and overall frame thickness were larger than the respective length, width, and thickness of either of the solid-state cathode layers of the double-sided solid-state cathode.

The double-sided cathode assembly was then heated at a temperature of about 65° C. to about 75° C. and at a pressure of about 70 kPa to about 700 kPa for 2 minutes. The assembly was then taken out and allowed to cool to room temperature.

Next, the double-sided cathode assembly was automatically stacked on the top of a lithium-stuffed garnet solid-state separator assembly from above, with respect to the separator center. The bonding layer contacted one cathode layer of the double-sided cathode and the separator contacted the frame. Then a second lithium-stuffed garnet solid-state separator assembly was automatically stacked on top of the double-sided cathode assembly with the bonding layer facing the second layer of the double-sided cathode to form a stack.

Finally, the stack was heated at a temperature of about 80° C. to about 160° C. and at a pressure of about 70 kPa to about 700 kPa for a few minutes.

### Example 5—Cell Performance Study

Electrochemical cells were assembled as in Examples 1-4, with varying frame layer numbers and thermoplastic polymers. The electrochemical cells were tested by 1C CC-CV (constant current-constant voltage) charge—1C CC (constant current) discharge at 30° C. The cycle number was defined by the numbers of cycles where the capacity retention is greater than 80%. The results are shown in Table 1. A represents a cycle number of 1000+ cycles, B represents 200-1000 cycles, and C represents <200 cycles.

PEX refers to a cross-linked, maleic anhydride polyethylene copolymer, PI refers to a polyimide polymer, PEEK refers to a polyether ether ketone polymer, PIB refers to a polyisobutylene polymer, and PTFE refers to a polytetrafluoroethylene polymer.

TABLE 1
Frame Comparison

| | # of | First (and | Second | |
|---|---|---|---|---|
| | polymer | third) polymer | polymer | Cycle |
| | layers | layer | layer | Number |
| Frame 1 | 2 layers | PIB | PEEK | C |
| Frame 2 | 2 layers | PEX | PEEK | A |
| Frame 3 | 2 layers | PEX | PI | A |
| Frame 4 | 2 layers | PEX | PTFE | B |
| Frame 5 | 3 layers | PEX | PEEK | B |
| Frame 6 | 3 layers | PEX | PI | B |
| Frame 7 | 3 layers | PEX | PTFE | B |
| Frame 8 | 3 layers | PEX | Porous PI | B |

### Example 6—X-Ray Cross-Linking and Heat Deformation

A maleic anhydride polyethylene copolymer was modified by irradiating with X-rays to induce cross-linking in the polymer.

The heat deformation as a function of temperature (room temperature to 200° C.) was measured for the cross-linked maleic anhydride polyethylene copolymer as well as for a non-crosslinked, maleic anhydride polyethylene copolymer. The non-cross-linked polymer begins deforming around 100° C. and experiences up 100% deformation at around 160° C. In contrast, the cross-linked polymer begins deforming at greater than 115° C. and experiences no more than 10% deformation at up to 200° C.

### Example 7—X-Ray Cross-Linking and Tensile Strength

A maleic anhydride polyethylene copolymer was separately modified by irradiating with X-rays with 25 kGy, 50 kGy, or 100 kGy strength to induce cross-linking.

The tensile strength as a function of temperature (room temperature to 200° C.) was measured for each cross-linked polymer as well as for a non-crosslinked, maleic anhydride polyethylene copolymer (0 kGy). The non-radiated sample (i.e, 0 kGy) exhibited a sharp drop off in tensile strength at 110° C., corresponding with a drop close to five orders of magnitude in the tensile modulus. The measured tensile modulus values for each polymer at 110° C. were 1 kPa for the non-crosslinked polymer (0 kGy), 600 kPa for the sample irradiated with 25 kGy, 600 kPa for the sample irradiated with 50 kGy, and 1440 kPa for the sample irradiated with 100 kGy. The respective tensile modulus of each cross-linked sample did not fall below three orders of magnitude from the initial tensile modulus with temperatures up to 200° C.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical stack comprising:
a solid-state cathode having two major surfaces, four minor surfaces, a first width and a first length, the solid-state cathode comprising a solid catholyte;
a solid-state separator having a second width and a second length;
a cathode current collector;
a bonding layer; and
a frame;
wherein the frame surrounds the four minor surfaces of the solid-state cathode;
wherein the frame is positioned between and contacts the cathode current collector and the solid-state separator;
wherein the bonding layer is positioned between and contacts the solid-state cathode and the solid-state separator; and
wherein the first width is smaller than the second width; and the first length is smaller than the second length.

2. The electrochemical stack of claim 1, wherein the frame is attached to the cathode current collector.

3. The electrochemical stack of claim 1, wherein the frame is attached to the solid-state separator and the cathode current collector.

4. The electrochemical stack of any one of claims 1-3, wherein the frame comprises a thermoplastic polymer.

5. The electrochemical stack of claim 4, wherein the thermoplastic polymer is selected from a polyethylene polymer, a polypropylene polymer, a polybutylene polymer, a polypentene polymer, a polystyrene polymer, a polyaryletherketone polymer, a polyaryletherimide polymer, a polysulfone polymer, an acrylate polymer, a polycarbonate polymer, or combinations thereof.

6. The electrochemical stack of any one of claims 4-5, wherein the thermoplastic polymer is selected from a modified polyethylene polymer, a modified polypropylene polymer, a modified polybutylene polymer, a modified polypentene polymer, a modified polystyrene polymer, a modified polyaryletherketone polymer, a modified polyaryletherimide polymer, a modified polysulfone polymer, a modified acrylate polymer, a modified perfluoroelastomer polymer, a modified polycarbonate polymer, or combinations thereof.

7. The electrochemical stack of any one of claims 4-6, wherein the thermoplastic polymer is selected from acrylonitrile butadiene styrene (ABS), ethylene-propylene rubber (EPM), ethylene propylene diene rubber (EPDM), fluorinated ethylene propylene (FEP), perfluoroelastomer (FFKM), polybutene-1 (PB-1), polycarbonate (PC), polyether ether ketone (PEEK), polyetherimide (PEI), polyether sulfone (PES), polyethylene terephthalate (PET), polyisobutylene (PIB), polyisoprene, poly(methyl methacrylate) (PMMA), polymethylpentene (PMP), polytetrafluoroethylene (PTFE), polyvinylidene difluoride (PVDF), polyvinylidene difluoride-co-fluoro ethylene propylene (PVDF-co-FEP), poly(styrene-isoprene-styrene) (SIS), poly(styrene-butadiene-styrene) (SBS), ultra-high molecular-weight polyethylene (UHWPE), or combinations thereof.

8. The electrochemical stack of any one of claims 6-7, wherein the modified polyethylene polymer is a maleic anhydride polyethylene copolymer.

9. The electrochemical stack of claim 8, wherein the maleic anhydride polyethylene copolymer is cross-linked.

10. The electrochemical stack of any one of claims 1-9, wherein the frame comprises one or more layers.

11. The electrochemical stack of any one of claims 1-10, wherein the frame comprises two or more layers.

12. The electrochemical stack of any one of claims 1-11, wherein the frame comprises three or more layers.

13. The electrochemical stack of any one of claims 10-12, wherein each layer comprises a thermoplastic polymer.

14. The electrochemical stack of any one of claims 1-13, wherein the frame comprises a first layer and a second layer, and wherein the first layer of the frame and the second layer of the frame comprise the same thermoplastic polymer.

15. The electrochemical stack of any one of claims 1-13, wherein the frame comprises a first layer and a second layer, and wherein the first layer of the frame and the second layer of the frame comprise different thermoplastic polymers.

16. The electrochemical stack of claim 15, wherein the first layer of the frame comprises a cross-linked, maleic anhydride polyethylene copolymer.

17. The electrochemical stack of any one of claims 1-13, wherein the frame comprises a first layer, a second layer, and a third layer, and wherein the first layer of the frame and the third layer of the frame comprise the same thermoplastic polymer.

18. The electrochemical stack of any one of claims 1-13, wherein the frame comprises a first layer, a second layer, and a third layer wherein the first layer of the frame and third layer of the frame comprise different thermoplastic polymers.

19. The electrochemical stack of any one of claims 17-18, wherein the second layer of the frame comprises a different thermoplastic polymer than the first layer and the third layer.

20. The electrochemical stack of any one of claim 17 or 19, wherein the first layer of the frame and third layer comprise a cross-linked, maleic anhydride polyethylene copolymer.
